(19) United States
(12) Patent Application Publication
(10) Pub. No.: US 2026/0018168 A1
(43) Pub. Date: Jan. 15, 2026

(54) UTTERANCE DATA GENERATING DEVICE, DIALOGUE DEVICE AND GENERATION MODEL CREATING METHOD

(71) Applicant: National Institute of Information and Communications Technology, Tokyo (JP)

(72) Inventors: Ryu IIDA, Tokyo (JP); Kentaro TORISAWA, Tokyo (JP); Junta MIZUNO, Tokyo (JP); Julien KLOETZER, Tokyo (JP)

(73) Assignee: National Institute of Information and Communications Technology, Tokyo (JP)

(21) Appl. No.: 18/870,078

(22) PCT Filed: May 12, 2023
(86) PCT No.: PCT/JP2023/017833

§ 371 Date: Sep. 30, 2025

(30) Foreign Application Priority Data
Jun. 17, 2022 (JP) 2022-097746

(51) Int. Cl. G10L 15/22; G06F 16/632; G10L 15/06; G10L 15/28

(52) U.S. Cl. CPC G10L 15/22; G06F 16/632; G10L 15/063; G10L 15/285

(57) ABSTRACT

An utterance data generating device providing a dialogue device, a training device and an utterance data generating device that enable highly efficient generation of cache data in a dialogue device, includes: a cache data generating device generating, from each of a plurality of passages, cache data including an utterance word sequence forming a response utterance to an input utterance and a key word sequence to be a key for searching for an utterance word sequence; and a cache data storage device storing the cache data generated by the cache data generating device in a manner at least allowing reading by using the key word sequence as a key.

### CROSS-REFERENCE TO RELATED APPLICATIONS

This application is a national phase of International Application No. PCT/JP2023/017833 filed May 12, 2023, which claims priority to Japanese Application No. 2022-097746 filed Jun. 17, 2022, each of which is hereby incorporated herein by reference in its entirety.

### BACKGROUND ART

With the improvement of computer performance and the development of computer technique for processing natural language, the era of human interaction with computers is drawing near. Different from the past, such interaction is assumed to be open domain. Further, it is expected that interaction between computers and humans in natural dialogues, not only the dialogues for obtaining answers to specific problems, becomes commonly available.

As a system for such interaction, an example is known (Non-Patent Literature 1) in which a question-answering system having a large-scale passage group collected from the Web as a knowledge source is prepared, and contents appropriate as an answer to a user's utterance are extracted from the passage group to generate a response. FIG. 1 shows its outline. Here, a passage refers to a part of document and, for example, it consists of about five to about nine continuous sentences.

Referring to FIG. 1, in the dialogue system 50, a dialogue engine 62 executes a question creating process 110 for creating a large number of questions 120 from a user utterance 60. These questions 120 are input to a question-answering system 122. Question-answering system 122 generates, from a large-scale passage set 64 including an enormous number of passages collected from the Web, answers 124 for each of the questions. Dialogue engine 62 executes a response generating process 126 of generating responses from these enormous number of answers 124. Dialogue engine 62 does ranking 128 of these responses in terms of proper response to user utterance 60, and outputs the best response as a system response 66.

The above-described dialogue system 50 generates a response to user utterance 60 based on very wide knowledge represented by large-scale passage set 64. Therefore, a proper response can be given regardless of the domain of user utterance 60. The dialogue system 50, however, has a problem of high processing load. The reason for this is that dialogue engine 62 is required to execute a complicated task of creating a large number of questions 120 for one utterance, searching for a passage as a proper answer to each of the questions from the large-scale passage set 64, and selecting the best answer therefrom. In this process, a number of various deep learning-based processes are executed in parallel. Computational resources for this purpose are huge, and hence, it may take a long time for the final response to be output.

A solution to this problem is to cache system utterances 66 output from dialogue engine 62. By way of example, as shown in FIG. 1, a topic word sequence is extracted by a topic extracting unit 68 from user utterance 60. The topic word sequence refers to a central word sequence of user utterance 60. A topic word sequence is output by inputting user utterance 60 to a topic model that consists of a neural network trained beforehand by using training data that consists of the pairs of an utterance and word(s) considered to be central to respective utterance. Topic extracting unit 68 is equipped with this topic model, and extracts a topic word sequence from the user utterance 60 by inputting user utterance 60 to the topic model.

Cache data creating unit 80 creates cache data, each of which consists of the topic word sequence, system response 66 and the passage as the source of system response 66 in the large-scale passage set 64. Cache data creating unit 80 stores the cache data in dialogue processing cache data 82. When another user utterance 60 is input next, topic extracting unit 68 extracts the topic word sequence from the user utterance 60. A cache searching unit 84 searches for cache data that has the same topic word sequence in dialogue processing cache data 82. If searched cache data is found, cache searching unit 84 outputs a system utterance in the searched cache data. Cache searching unit 84 sends a notice 92 indicating whether the searched cache data is found or not, to dialogue engine 62. If the searched cache data is not found, dialogue engine 62 conducts usual response generation and outputs a system response 66.

Dialogue system 50 has a selecting unit 88, which receives system response 66 as the first input and an output of cache searching unit 84 as the second input. Cache searching unit 84 sends a control signal 94 to selecting unit 88 to make the selecting unit 88 select the second input if there is some cache data matching the topic word sequence extracted by topic extracting unit 68 and select the first input if such cache data is not found. As a result, if any cache data that has a proper response to user utterance 60 is already stored in dialogue processing cache data 82, dialogue system 50 can output system utterance 90 without heavy computational load. If such cache data is not found, dialogue system 50 generates system response 66 in a usual manner and outputs it as system utterance 90.

### CITATION LIST

### Non-Patent Literature

NPL 1: National Institute of Information and Communications Technology, “Kaiwasuru AI, Jisedai Onsei Taiwa system ‘WEKDA’” (“WEKDA,” a next-generation spoken dialogue system based on conversational AI) [Online] Oct. 24, 2017, searched on Jun. 1, 2022, <URL: https://www.nict.go.jp/press/2017/10/24-1.html >

### SUMMARY OF INVENTION

### Technical Problem

Dialogue system 50, however, stores a plurality of records per topic word sequence and needs to store huge cache data in order to response to various and many topics. In the prior art, in order to efficiently create records in cache data, it may be possible to automatically create questions for a set of substantial number of topic word sequences obtained beforehand, to input the questions into dialogue engine 62 and to use the system utterances output by dialogue engine 62. If a large number of cache records are to be created, however, the amount of processing of dialogue system 50 also increases, causing the computational cost to be very high. Therefore, it is difficult to create cache data efficiently.

Further, in order to update contents of large-scale passage set 64 and to reflect daily-updated information on the Internet, web-crawling is necessary. In that case also, cache data reflecting new information cannot be create unless a large number of questions are input to dialogue system 50. Therefore, overloading dialogue engine 62 is inevitable.

Therefore, an object of the present invention is to provide methods of creating utterance data generating devices, dialogue devices and generation models that can efficiently generate cache data of utterance data in a dialogue device.

### Solution to Problem

According to the first aspect, the present invention provides an utterance data generating device for a dialogue device, including: a response utterance generating means for generating, from each of a plurality of passages, a word sequence pair of an utterance word sequence forming a response utterance to an input utterance and a key word sequence to be a key for retrieving the utterance word sequence; and a word sequence pair storage device for storing the word sequence pair generated by the response utterance generating means in a manner allowing reading at least using the key word sequence as a key.

Preferably, the key word sequence is a topic word sequence representing a topic of the input utterance.

More preferably, the key word sequence is an input utterance word sequence representing the input utterance.

More preferably, the response utterance generating means includes a trained word sequence generation model, trained to generate, when a passage is given, a word sequence including a key word sequence and an utterance word sequence separated from each other by a prescribed separated tokens, from the passage.

Preferably, the response utterance generating means includes a first word sequence generation model pre-trained to generate, when a passage is given, an utterance word sequence, and a second word sequence generation model pre-trained to generate, when a passage and an utterance word sequence are given, the key word sequence.

More preferably, the response utterance generating means includes: a word classification model trained such that when a passage is given, the first label is added to a word forming an utterance word sequence and the second label different from the first label is added to a word forming a key word sequence, for the words included in the passage; an utterance word sequence generating means for generating, from the words having the first label added in the passage, an utterance word sequence; and a key word sequence generating means for generating, from the words having the second label added in the passage, a key word sequence.

More preferably, the response utterance generating means includes: an extracting means for extracting a plurality of parts from each of a plurality of passages; and an output word sequence generating means, trained such that, for each of the parts extracted by the extracting means, upon receiving the part as an input, it outputs an output word sequence including a pair of word sequences.

Preferably, each of the parts extracted by the extracting means is a sentence forming the passage given to the extracting means.

More preferably, each of the plurality of parts obtained by the extracting means includes one or more sentences.

More preferably, each of the plurality of parts obtained by the extracting means is one sentence or a character sequence shorter than one sentence.

Preferably, the response utterance generating means further includes: a selecting means for selecting, among the plurality of parts extracted by the extracting means, only a part satisfying a prescribed standard, and inputting the part to the output word sequence generating means.

More preferably, the utterance data generating device further includes: a selecting means for selecting, from the word sequence pairs generated by the response utterance generating means, only that one which satisfies a prescribed standard, and storing the selected ones in the word sequence pair storage device.

According to the second aspect, the present invention provides a dialogue device, including: an utterance generating means responsive to an input utterance, for generating a response utterance; and a storage device for storing a cache record including the response utterance and a key word sequence derived from the input utterance for retrieving the response utterance; wherein the storage device stores a cache record including a word sequence pair comprised of an utterance word sequence forming a response utterance to an input utterance generated from each of a plurality of passages and a word sequence to be a key for retrieving the utterance word sequence; and the utterance generating means includes a response utterance retrieving means, responsive to the input utterance, for retrieving, from the storage device, a cache record including, as the key word sequence, an input word sequence derived from the input utterance.

According to the third aspect, the present invention provides a method of creating generation model used in a dialogue device which, in response to an input utterance, generates a response utterance based on a passage set including a plurality of passages, and includes a storage device for storing a cache record including the response utterance and a key word sequence derived from the input utterance for retrieving the response utterance, the model having a function of generating a record for retrieving a response, the record having the same format as the cache record, based on any passage. The method of creating generation model includes the steps of: generating a training record used for training the generation model, by combining the response utterance and the key word sequence included in the cache record stored in the storage device with an original passage as the passage used by the dialogue device for generating the response utterance; and training the generation model, by using, for each of a plurality of training records generated at the step of generating a training record, the original passage included in the training record as an input and a word sequence obtained by shaping the response utterance included in the training record and the key word sequence included in the training record to a prescribed format as a correct answer.

Preferably, the creating method further includes the step of selecting, from the cache records stored in the storage device, only those ones which satisfy a prescribed standard, and reading the selected ones from the storage device as an input to the step of generating the training record.

More preferably, the training step includes the step of training a generation model, by using, for each of the training records generated at the step of generating the training record, the original passage included in the training record as an input, and using a word sequence obtained by coupling the key word sequence included in the training record and a response utterance included in the training record with a prescribed separated tokens interposed as a correct answer.

Further preferably, the key word sequence is a topic word sequence related to the input utterance.

Preferably, the key word sequence is a word sequence forming the input utterance.

According to the fourth aspect, the present invention provides a natural language sentence generation model creating method, including the steps of: based on an input utterance, creating a plurality of question sentences, inputting them to a question-answering system and thereby obtaining a plurality of answer sentences output from the question-answering system; based on the plurality of answer sentences obtained at the step of obtaining answer sentence, generating a response utterance to the input utterance; generating training data for a natural language sentence generation model using, for each of the plurality of answer sentences, the answer sentence as an input and a combination of the response utterance obtained from the answer sentence with the input utterance as correct answer data; and training the generation model by using the training data generated at the step of generating training data; wherein in the correct answer data, one of the response utterance and the input utterance is used as a response utterance word sequence and the other is used as a key word sequence for retrieving the response utterance.

Preferably, the response utterance word sequence is the response utterance, and the key word sequence is the input utterance.

More preferably, the response utterance word sequence is the input utterance, and the key word sequence is the response utterance.

Further preferably, the step of generating the training data includes the step of generating the training data by using, for each of the plurality of answer sentences, the answer sentence as an input and using the combination of the question sentence from which the answer sentence is obtained, the response utterance obtained from the answer sentence and the input utterance as correct answer data.

### BRIEF DESCRIPTION OF DRAWINGS

FIG. 1 is a block diagram showing a configuration of a conventional dialogue system.

FIG. 2 is a block diagram showing a configuration of a cache data generating device in accordance with the first embodiment of the present invention.

FIG. 3 is a block diagram showing a configuration of a cache data generation model training unit for training the cache data generation model shown in FIG. 2.

FIG. 4 shows an example of the configuration of training data used by the cache data generation model training unit.

FIG. 5 is a block diagram showing a configuration of the cache data generating device in accordance with the second embodiment of the present invention.

FIG. 6 shows an example of the configuration of training data for a topic word sequence generation model forming the topic word sequence adding unit shown in FIG. 5.

FIG. 7 shows an example of training data for a system utterance generation model forming the system utterance adding unit shown in FIG. 5.

FIG. 8 is a block diagram showing a configuration of the cache data generating device in accordance with the third embodiment of the present invention.

FIG. 9 shows an example of the configuration of training data for the system utterance generation model forming the system utterance generating unit shown in FIG. 8.

FIG. 10 shows an example of the configuration of training data for the topic word sequence generation model forming the topic word sequence adding unit shown in FIG. 8.

FIG. 11 is a block diagram showing a configuration of a model training system for training the cache data generation model in the cache data generating device in accordance with the fourth embodiment of the present invention.

FIG. 12 is a block diagram showing a configuration of the cache data generating device in accordance with the fifth embodiment of the present invention.

FIG. 13 shows a process of generating the cache data by the model training system shown in FIG. 12.

FIG. 14 is a block diagram schematically showing a configuration of the classification model shown in FIG. 12.

FIG. 15 is a block diagram showing a configuration of the training data generating device of the classification model shown in FIG. 14.

FIG. 16 shows a process of generating the training data by the training data generating device shown in FIG. 15.

FIG. 17 is a block diagram showing a configuration of the training system for training the system utterance generation model shown in FIG. 12.

FIG. 18 shows a process of generating the training data by the training data generating device shown in FIG. 17.

FIG. 19 is a block diagram of a dialogue device that uses the cache data generated by the cache data generating device in accordance with the sixth embodiment of the present invention.

FIG. 20 is a block diagram showing a configuration of the cache data generating device in accordance with the sixth embodiment of the present invention

FIG. 21 is a flowchart showing a control structure of the computer program realizing the passage reading unit and the object sentence selecting unit shown in FIG. 20.

FIG. 22 is a block diagram showing a configuration of the system generating the training data for the cache data generation model used by the cache data generating unit of the cache data generating device in accordance with the sixth embodiment.

FIG. 23 is a schematic diagram showing an example of the cache data generating procedure in accordance with the sixth embodiment.

FIG. 24 is a schematic diagram showing an example of the cache data generating procedure in accordance with a modification of the sixth embodiment.

FIG. 25 shows an example of the configuration of training data for the cache data generation model in accordance with the sixth embodiment.

FIG. 26 shows an example of the configuration of training data for the cache data generation model in accordance with a modification of the sixth embodiment.

FIG. 27 shows evaluations of experiments conducted on the sixth embodiment and its modification.

FIG. 28 shows evaluations of experiments conducted on the sixth embodiment and its modification.

FIG. 29 is a block diagram showing a configuration of the system generating the training data for the cache data generating device in accordance with the seventh embodiment of the present invention.

FIG. 30 is a block diagram showing a configuration of the question-answering device that uses the cache data in accordance with the eighth embodiment of the present invention.

FIG. 31 is a schematic block diagram of the cache data generating device in accordance with the eighth embodiment of the present invention.

FIG. 32 is a schematic block diagram of the training data generating device for the cache data generation model shown in FIG. 31.

FIG. 33 shows an appearance of the computer for realizing the embodiments of the present invention.

FIG. 34 is a block diagram showing the hardware configuration of the computer shown in FIG. 33.

### DESCRIPTION OF EMBODIMENTS

In the following description and in the drawings, the same components are denoted by the same reference numbers. Therefore, detailed description thereof will not be repeated.

### 1. First Embodiment

### A. Configuration

### Cache Data Generating Device

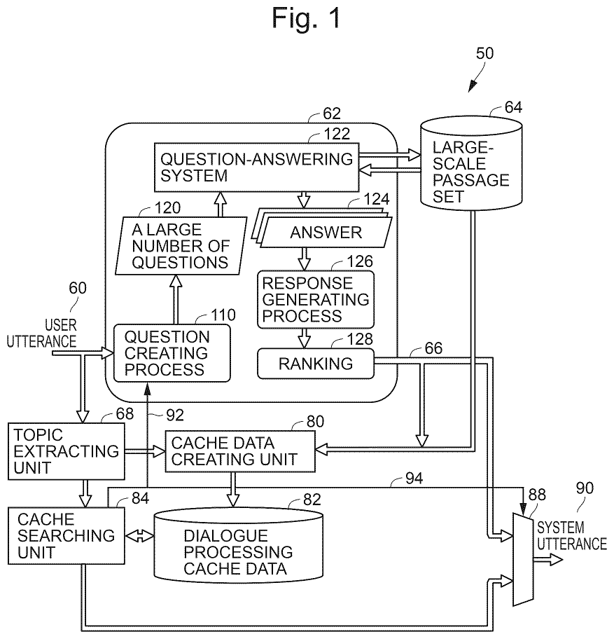

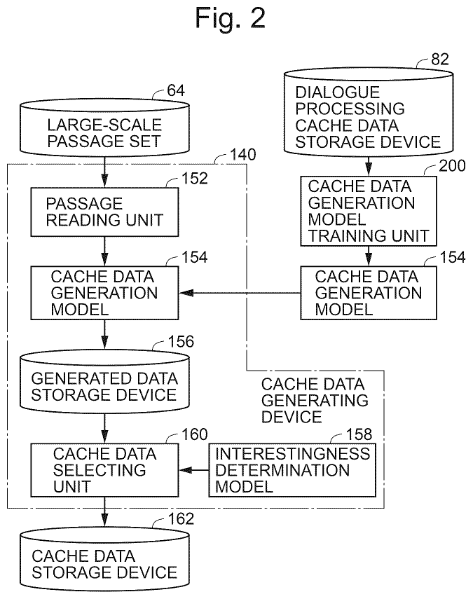

Referring to FIG. 2, a cache data generating device 140 in accordance with the first embodiment of the present invention generates cache data for a dialogue system 50 shown in FIG. 1 from a large-scale passage set 64, and stores in cache data storage device 162. Large-scale passage set 64 may be prepared in the form of text files in which a plurality of passages is stored one by one in order, or it may be prepared in the form of database having a plurality of records each storing a passage. The data generated by cache data generating device 140 is generated for response retrieval, and it can be used in the manner similar to the cache data obtained by dialogue system 50. The data, however, is not the cache data generated by the common method. Therefore, in order to clearly distinguish these from each other, the data generated by cache data generating device 140 may be better referred to as pseud cache data substituting the cache data, or referred to as response retrieval data. In the following description, however, these two can substantially be distinguished and, for simplicity, both data will be referred to as cache data.

Cache data generating device 140 includes: a passage reading unit 152 for reading passages one by one from large-scale passage set 64; and a cache data generation model 154 for generating cache data having the same format as each of the data items forming the cache data stored in dialogue processing cache data 82 shown in FIG. 1, from the passage read by passage reading unit 152. As the cache data generation model 154, a transformer-encoder-decoder (hereinafter referred to as “transformer”) is used, which is frequently used for natural language processing and of which effect has been practically confirmed, as described later. Training of the transformer, which is the generation model of natural language sentences forming the cache data generation model 154, will be described later. The transformer is used as the cache data generation model not only in the first embodiment but also in other embodiments. It is needless to say that the model is not limited to the transformer, and any model may be used provided that it is capable of generating natural language sentences and that it can be trained.

Cache data generating device 140 further includes: a generated data storage device 156 for storing cache data generated by cache data generation model 154; and a cache data selecting unit 160 for selecting, from the cache data stored in generated data storage device 156, those having interestingness score equal to or higher than a threshold value, by using a pre-prepared interestingness determination model 158. The cache data selected by cache data selecting unit 160 is stored in cache data storage device 162.

In the present embodiment, cache data generation model 154 is pre-trained by a cache data generation model training unit 200, using the cache data stored in dialogue processing cache data 82 shown in FIG. 1. In the present embodiment, the cache data stored in dialogue processing cache data 82 has such a format that includes a topic word sequence derived from the user utterance and a word sequence of system utterance corresponding to the user utterance, and further includes a word sequence of the passage (hereinafter referred to as the “original passage”) as the source for generating the response. Therefore, cache data generation model training unit 200 trains cache data generation model 154 using a cache data passage as an input, and using a word sequence having the same format as the cache data obtained by concatenating the topic word sequence of the cache data, a prescribed delimiter, and the system utterance, as correct answer data.

Cache data storage device 162 stores the cache data such that records of cache data can be read using at least the topic word sequence as a key, that is, a key word sequence. As the cache data, the original passage is unnecessary. In the present embodiment, however, the original passage is included in the cache data. The reason for this is that, when cache data is to be further generated using the cache data generated from user utterance 60, the original passage becomes necessary, as will be described later. If such use is not intended, it is unnecessary to include the original passage in the cache data.

The interestingness determination model 158 is formed of a pre-prepared neural network. Interestingness determination model 158 outputs a score for an utterance, from the viewpoint of whether the input utterance is usable or not as an utterance and whether or not it is interesting. Interestingness determination model 158 is trained using training data obtained by adding, to a large number of word sequences prepared in advance, labels indicating whether each utterance can be used as a system utterance, and whether it is interesting when used.

### Cache Data Generation Model Training Unit 200

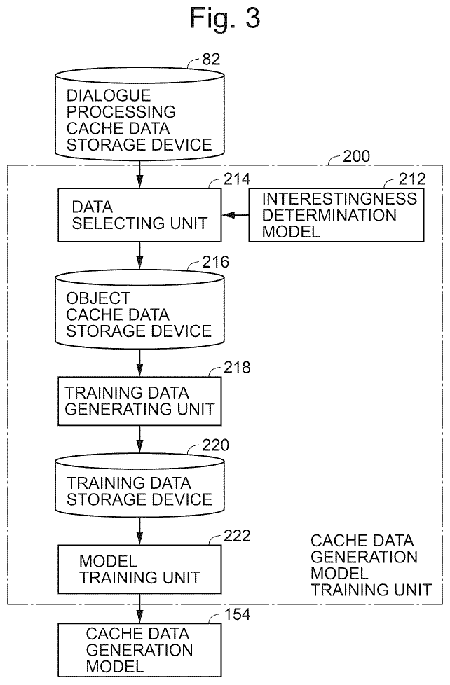

FIG. 3 shows more detailed configuration of cache data generation model training unit 200 of FIG. 2. Referring to FIG. 3, cache data generation model training unit 200 includes a data selecting unit 214 that reads each record of cache data stored in dialogue processing cache data 82, and selects only the ones of which score given by interestingness determination model 212 indicating the interestingness of the record is equal to or higher than a threshold value. The interestingness determination model 212 is similar to interestingness determination model 158 shown in FIG. 2.

Cache data generation model training unit 200 further includes: an object cache data storage device 216 for storing each record of the cache data selected by data selecting unit 214; and a training data generating unit 218 for generating training data for training cache data generation model 154 using each record stored in object cache data storage device 216. The function of training data generating unit 218 is to generate the training data that has the passage included in the object record as the input and the word sequence obtained by concatenating the topic word sequence included in the object record and the word sequence of system utterance with a delimiter as a correct answer, as described above.

Cache data generation model training unit 200 further includes: a training data storage device 220 for storing the training data generated by training data generating unit 218;

and a model training unit 222 for training cache data generation model 154 by using the training data stored in training data storage device 220.

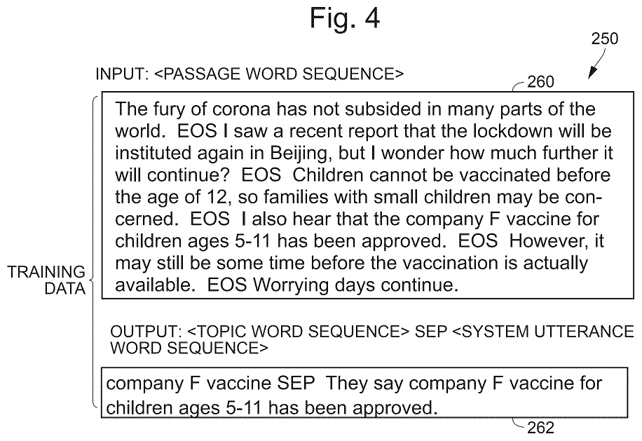

FIG. 4 shows an example of the record of training data stored in training data storage device 220. In the following, for simplicity of description, the record of training data will be simply referred to as “training record.” Referring to FIG. 4, the training record 250 is a set of passage word sequence 260 input to cache data generation model 154 and output word sequence 262 of correct answer data that is to be output from cache data generation model 154. Training data generating unit 218 generates output word sequence 262 by concatenating, with a delimiter (in FIG. 4, represented by “SEP”, same in other drawings), a topic word sequence obtained from the user utterance (for example, “company F vaccine”) and a word sequence of system utterance (for example, “They say the company F vaccine for children ages 5-11 has been approved”). Though each word sequence in the passage word sequence 260 and output word sequence 262 are separated by spaces, for saving space, in the specification, spaces between words are omitted.

### B. Operation

Cache data generating device 140 shown in FIG. 2 operates in the following manner. Before the operation of cache data generating device 140, cache data generation model 154 must be trained. Therefore, training of cache data generation model 154 will be described.

Referring to FIG. 3, a plurality of pieces of cache data are formed, for example, by dialogue system 50 shown in FIG. 1 and stored in dialogue processing cache data 82. It is also assumed that interestingness determination model 212 is already trained.

Data selecting unit 214 reads each record of cache data stored in dialogue processing cache data 82, and inputs each record to interestingness determination model 212. In response to the input record, interestingness determination model 212 outputs the score indicating the interestingness of the system utterance included in the record. Data selecting unit 214 selects, from the records of cache data read from dialogue processing cache data 82, only the ones having the score equal to or higher than the threshold value, and stores these in object cache data storage device 216.

Training data generating unit 218 generates training data for cache data generation model 154 by using each record stored in object cache data storage device 216, and stores the data in training data storage device 220. Specifically, training data generating unit 218 generates training data that has a passage included in the object record as an input and a word sequence obtained by concatenating the topic word sequence included in the object record, a delimiter, and the word sequence of system utterance as a correct answer.

Model training unit 222 trains cache data generation model 154 using the training data stored in training data storage device 220. By this training, cache data generation model 154 comes to generate and output, when a passage is given, probability distribution of each word sequence as the topic word sequence and probability distribution of each word sequence as the system utterance.

Referring to FIG. 2, when training of cache data generation model 154 is completed, cache data generation model training unit 200 becomes operable. In large-scale passage set 64, an enormous number of passages collected, for example, from the WEB is stored as has been described with reference to FIG. 1.

Passage reading unit 152 reads passages one by one from large-scale passage set 64, and inputs to cache data generation model 154. In response to the input passage, cache data generation model 154 outputs probability distribution of topic word sequence and probability distribution of word sequence of system utterance. For simplicity of description, here, it is assumed that the word having the highest probability among the topic word sequences is selected as the topic word sequence, and that as the system utterance also, the word sequence having the highest probability of system utterance word sequence is selected as the system utterance word sequence. The topic word sequence and the system utterance word sequence selected in this manner are concatenated with a delimiter, and combined with the passage read by passage reading unit 152, to form a candidate of cache data. Cache data are temporarily stored in generated data storage device 156.

Cache data selecting unit 160 inputs, for example, each of the cache data candidates stored in generated data storage device 156 to interestingness determination model 158, so that the interestingness score of system utterance in each cache data is output. Cache data selecting unit 160 selects, from the candidates of system utterances stored in generated data storage device 156, those having the interestingness score by interestingness determination model 158 equal to or higher than a threshold value, and stores them in cache data storage device 162. In the present embodiment, generated data storage device 156 discards the system utterance candidates having the scores lower than the threshold value.

As described above, in the first embodiment, cache data generation model 154 is trained by using the cache data stored in dialogue processing cache data 82. Cache data generating device 140 generates a record of cache data from each of the passages stored in large-scale passage set 64 using cache data generation model 154, and stores only those records having the interestingness score equal to or higher than the threshold value as cache data in cache data storage device 162. Both in the operations of cache data generating device 140 shown in FIG. 2 and cache data generation model training unit 200 shown in FIG. 3, what is required is simple processing only, and since only the records having interestingness scores equal to or higher than the threshold value are selected, it is possible to prevent generation of cache data of non-interesting utterances as utterances of dialogue device.

In the present embodiment, cache data obtained by the above-described process is added to dialogue processing cache data 82 of the dialogue system 50 shown in FIG. 1. By this process, it is expected that when searching dialogue processing cache data 82 using a topic word sequence extracted by topic extracting unit 68 as a key word sequence, the number of records of the retrieved cache data will be significantly increased. As a result, the utterance data generating device, the dialogue device and the generation model creating method that enable efficient generation of cache data in the dialogue device can be provided. In dialogue system 50 shown in FIG. 1, it may be the case that the function of using cache data is newly added to one that does not originally have the function of using any cache data. In such a case, with no record in dialogue processing cache data 82 shown in FIG. 1, the cache data generated by a separate device in accordance with the method of the first embodiment can be stored, and the same function as dialogue system 50 can be realized. In this case also, it is true that the cache data is added to the dialogue processing cache data 82, and this type of device is also encompassed by the first embodiment, as long as the cache data is generated by the device or method in accordance with the first embodiment above.

### 2. Second Embodiment

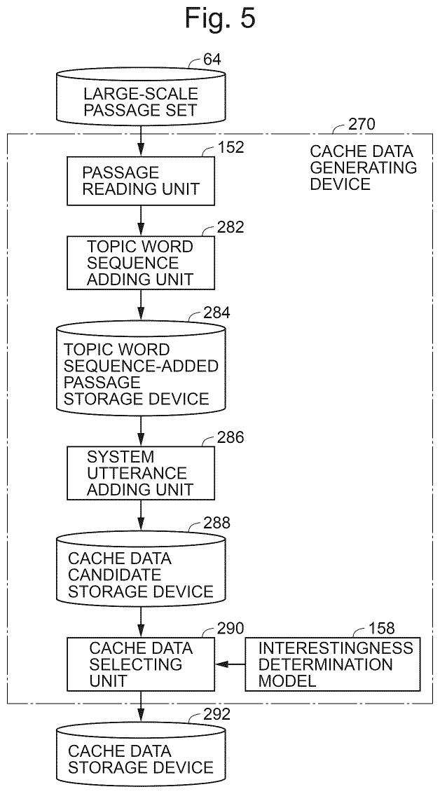

Referring to FIG. 3, in the second embodiment, in place of cache data generation model training unit 200 shown in FIG. 2 of the first embodiment, a cache data generating device 270 shown in FIG. 5 is used and, in this point, it is different from cache data generation model training unit 200. Different from training data generating unit 218, cache data generating device 270 does not directly generate cache data candidates from each of the passages.

Referring to FIG. 5, cache data generating device 270 includes: a passage reading unit 152 for reading each of the passages from large-scale passage set 64; and a topic word sequence adding unit 282 extracting a topic word sequence from the passage read by passage reading unit 152 and adding it to the passage.

Cache data generating device 270 further includes: a topic word sequence-added passage storage device 284 for storing the passage with topic word sequence added, output from topic word sequence adding unit 282; and a system utterance adding unit 286 for generating a system utterance word sequence from each of the passages stored in topic word sequence-added passage storage device 284, adding the same to the passage and outputting the result as a cache data candidate. System utterance adding unit 286 receives each passage as an input, concatenates the topic word sequence assigned to the passage and the system utterance candidate with a delimiter, and combines the obtained word sequence with the passage, to provide a cache data candidate.

Cache data generating device 270 further includes: a cache data candidate storage device 288 for storing cache data candidates output from system utterance adding unit 286; and a cache data selecting unit 290 inputting each of the cache data stored in cache data candidate storage device 288 to interestingness determination model 158 to calculate score of the system utterance included in the cache data, and selecting and outputting only the ones having the score equal to or higher than a threshold value.

The cache data selected by cache data selecting unit 290 is stored in cache data storage device 292.

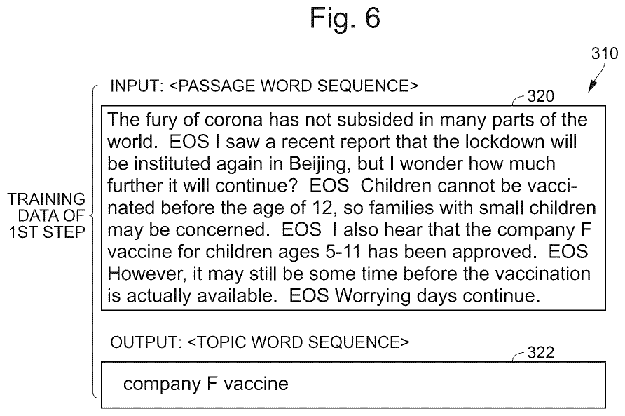

Topic word sequence adding unit 282 and system utterance adding unit 286 are both realized by a neural network that can generate natural language sentences. FIG. 6 shows an example of the configuration of training data for the neural network that generates a topic word sequence from a passage, used in the first step of the process by topic word sequence adding unit 282.

Referring to FIG. 6, training data 310 of the neural network for topic word sequence adding unit 282 is a set of passage word sequence 320 and the topic word sequence 322 that is paired with passage word sequence 320 in the cache data stored in dialogue processing cache data 82. Passage word sequence 320 is the input, and topic word sequence 322 is the correct answer data (output). By training the neural network using the training data 310, the topic word sequence adding unit 282 shown in FIG. 5 is obtained.

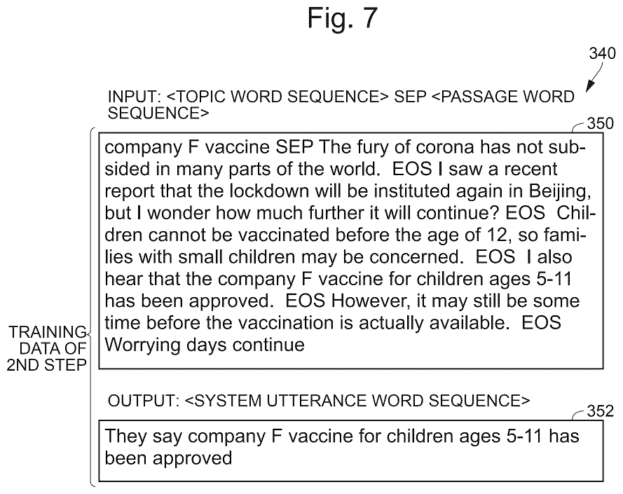

FIG. 7 shows an example of the configuration of training data for the neural network that generates a system utterance word sequence from the topic word sequence-added passage word sequence, used in the second step of the process by system utterance adding unit 286 shown in FIG. 5. Referring to FIG. 7, training data 340 has, as an input, a word sequence 350, which is obtained by concatenating a topic word sequence stored in the topic word sequence-added passage storage device 284 and a passage word sequence with a delimiter. Training data 340 further includes, as the correct answer data (output), system utterance word sequence 352 stored as cache data in dialogue processing cache data 82 of FIG. 1 paired with the passage, which sequence is combined with word sequence 350.

As described above, in the cache data generating device 270 in accordance with the second embodiment, the topic word sequence and the system utterance word sequence are generated separately in this order, and thereafter, shaped to the cache data format and accumulated as cache data. A large amount of computational resources is unnecessary for generating the cache data. By adding the cache data to the dialogue processing cache data 82 shown in FIG. 1, the probability of a system utterance corresponding to user utterance 60 being a hit in dialogue processing cache data 82 becomes higher, and efficiency of dialogue system 50 can be improved.

### 3. Third Embodiment

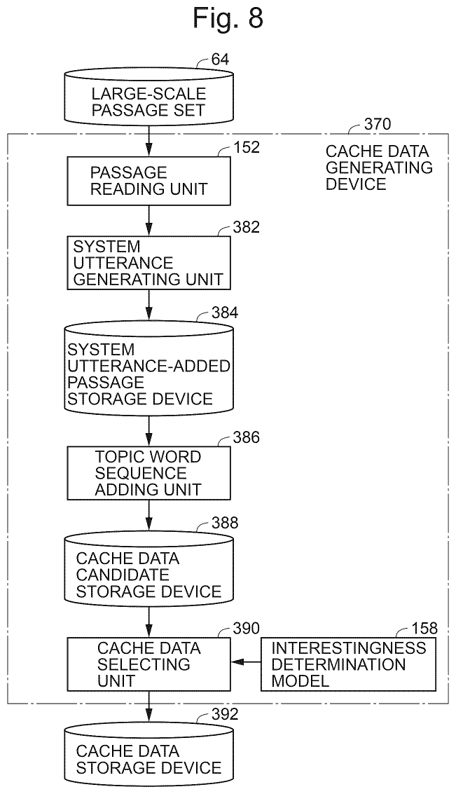

In the second embodiment, for generating cache data, a topic word sequence is extracted from a passage as the first step, and a system utterance word sequence is inferred from the topic word sequence-added passage as the second step. The present invention, however, is not limited to such an embodiment. A system utterance word sequence may be inferred from a passage first and then a topic word sequence may be inferred from the system utterance word sequence-added passage. FIG. 8 shows a configuration of a cache data generating device 370 that generates cache data in this manner.

Referring to FIG. 8, cache data generating device 370 includes: a passage reading unit 152 for reading a passage from large-scale passage set 64; a system utterance generating unit 382 for generating a system utterance word sequence from the passage read by passage reading unit 152, adding it to the passage and outputting the result; and a system utterance-added passage storage device 384 for storing the system utterance-added passage for storing the output of system utterance generating unit 382 at the first step of cache data generation.

Cache data generating device 370 includes: a topic word sequence adding unit 386 for reading, at the second step of cache data generation, the system utterance-added passage from system utterance-added passage storage device 384, adding a topic word sequence thereto, and shaping the result to the form of cache data and outputting; and a cache data candidate storage device 388 for storing cache data candidates output from topic word sequence adding unit 386.

Cache data generating device 370 further includes: a cache data selecting unit 390 for calculating, for each of the cache data candidates stored in cache data candidate storage device 388, a score using interestingness determination model 158, and for storing the cache candidate in cache data storage device 392 when the score of the cache data candidates is equal to or higher than a threshold value.

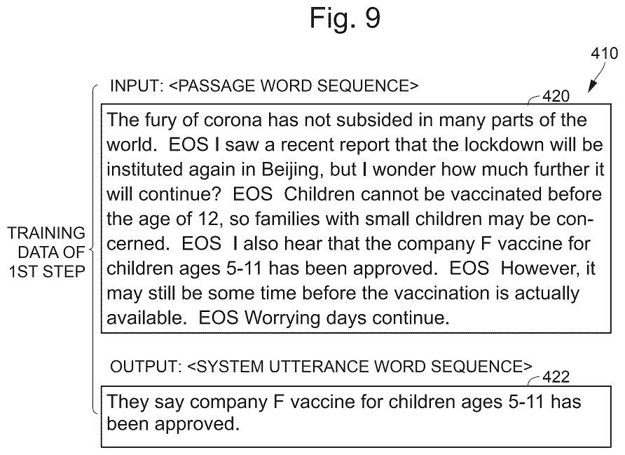

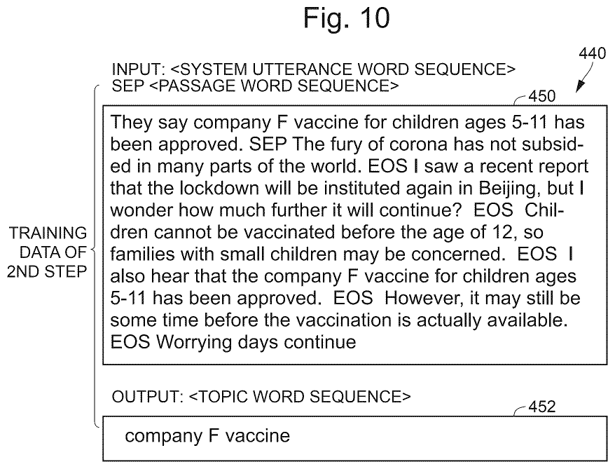

Topic word sequence adding unit 282 and system utterance adding unit 286 can both be realized by using a trained neural network that can generate natural language sentences. FIG. 9 shows an example of the configuration of training data for the neural network of system utterance generating unit 382 of the first step. FIG. 10 shows an example of the configuration of training data for the neural network of topic word sequence adding unit 386 of the second step.

Referring to FIG. 9, training data 410 for training the neural network of system utterance generating unit 382 has a passage word sequence 420 as an input and a system utterance word sequence 422 as correct answer data (output).

Referring to FIG. 10, training data 440 for training the neural network of topic word sequence adding unit 386 is a combination of a word sequence 450, which is obtained by concatenating the system utterance word sequence and the passage word sequence with a delimiter, as an input, and topic word sequence 452 as correct answer data (output).

As described above, in cache data generating device 370 in accordance with the third embodiment, the system utterance word sequence and the topic word sequence are generated separately in this order, and then shaped to the format of cache data and accumulated as cache data. A large amount of computational resources is unnecessary for generating the cache data. The cache data is added to the dialogue processing cache data 82 shown in FIG. 1. By doing this, the probability of a system utterance corresponding to user utterance 60 being a hit in dialogue processing cache data 82 becomes higher, and efficiency of dialogue system 50 can be improved.

At the second step of the third embodiment, the topic word sequence is inferred from the system utterance word sequence-added passage. The present invention, however, is not limited to such an embodiment. At the second step, the topic word sequence may be inferred from the system utterance word sequence. In that case, the machine learning model is trained to generate a topic word sequence, by using training data having a system utterance word sequence as an input and the corresponding topic word sequence as an output (correct answer). This machine learned model may be used as the model for inferring the topic word sequence.

### 4. Fourth Embodiment

In the first embodiment, for training the cache data generation model, cache data consisting of the topic word sequences obtained from actual user utterances and the system utterance word sequences is used as teacher data. It is noted, however, that the training data for training cache data generation model need not be based on the actual user utterances. If any dialogue data is available, by relating the dialogue data with passages, training data for training a cache data generation model can be generated.

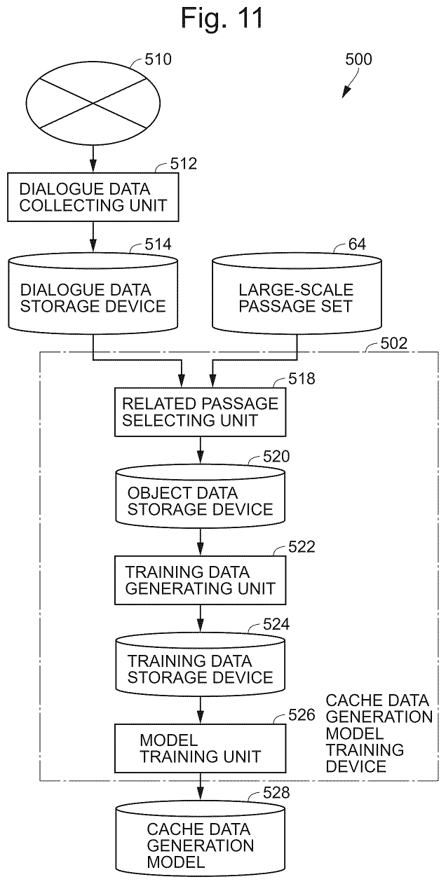

Referring to FIG. 11, a model training system 500 in accordance with the fourth embodiment includes: a dialogue data collecting unit 512 crawling the Internet 510 for collecting dialogue data from pages on which user dialogues are taking place; a dialogue data storage device 514 for storing the dialogue data collected by dialogue data collecting unit 512; and large-scale passage set 64. Model training system 500 further includes a cache data generation model training device 502, connected to dialogue data storage device 514 and to large-scale passage set 64, for generating training data for cache data generation model 528 using the dialogue data stored in dialogue data storage device 514 and the passages stored in large-scale passage set 64, for training cache data generation model 528.

The sites accessed by dialogue data collecting unit 512 may be any site to which a plurality of users access and communication among users take place, such as mini-blogs, blogs, comments on news pages and question-answering sites. Here, “dialogue” refers to a pair of utterance word sequences consisting of one utterance and a response to the utterance.

Cache data generation model training device 502 includes: a related passage selecting unit 518 that reads a pair of utterance word sequences stored in dialogue data storage device 514, for retrieving and reading from large-scale passage set 64 a passage having particularly high relation with the utterance word sequences; and an object data storage device 520 for storing the passage read by related passage selecting unit 518 and the pair of utterance word sequences used for retrieving, combined as a set, to be object data for generating the training data. In order to select a passage highly related to a pair of utterance word sequences, a method such as finding, as a measure of relatedness, large overlap between a word group appearing in the utterance word sequence and a word group appearing in the passage, may be used.

Cache data generation model training device 502 further includes: a training data generating unit 522 for generating training data for training cache data generation model 528 from the object data stored in object data storage device 520; a training data storage device 524 for storing the training data; and a model training unit 526 for training cache data generation model 528 using the training data stored in training data storage device 524.

Training data generating unit 522 extracts, for example, a topic word sequence from utterance word sequences preceding in time from the utterance word sequences in the object data. Further, training data generating unit 522 combines an utterance word sequence succeeding in time as a system utterance with the topic word sequence and the passage in the object data, and thereby generates the training data.

Training of cache data generation model 528 is done in the same manner as training of cache data generation model in accordance with the first to third embodiments.

As described above, by combining the dialogue data existing in large volume on the Internet 510 and the passages in large-scale passage set 64, a huge amount of training data can be generated.

If correspondence between the dialogue data and the passages can be found with high accuracy, the training data itself may be regarded as cache data. In that case, it is unnecessary to train cache data generation model 528.

### 5. Fifth Embodiment

In the first to third embodiments, the procedure of generating system utterance word sequences from passages is necessary in the step of generating cache data, as represented, for example, by cache data generation model 154 of FIG. 2, system utterance adding unit 286 of FIG. 5 and system utterance generating unit 382 of FIG. 8. As compared with the conventional example shown in FIG. 1, the computational load for generating cache data from passages is far smaller. Further reduction of computational load, however, is still desirable. The fifth embodiment proposes such an implementation.

### An Overall Configuration of Cache Data Generating Device

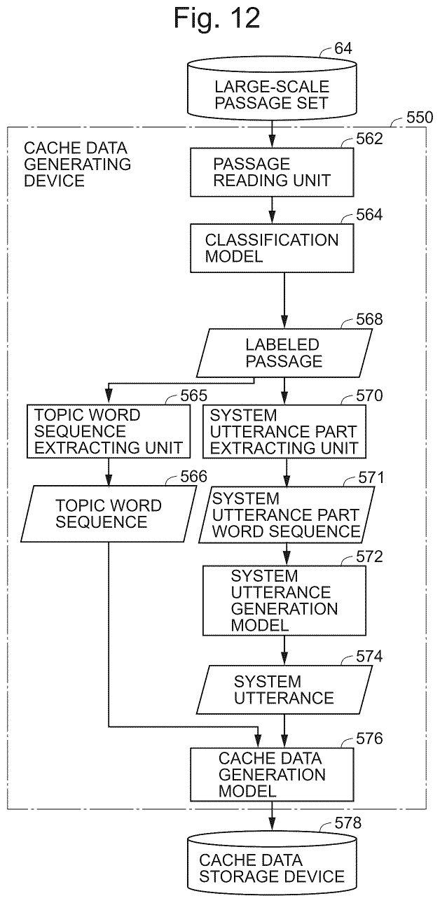

FIG. 12 shows, in a block diagram, the configuration of cache data generating device 550 in accordance with the fifth embodiment. Referring to FIG. 12, cache data generating device 550 is to generate cache data from large-scale passage set 64 and storing the generated cache data in a cache data storage device 578.

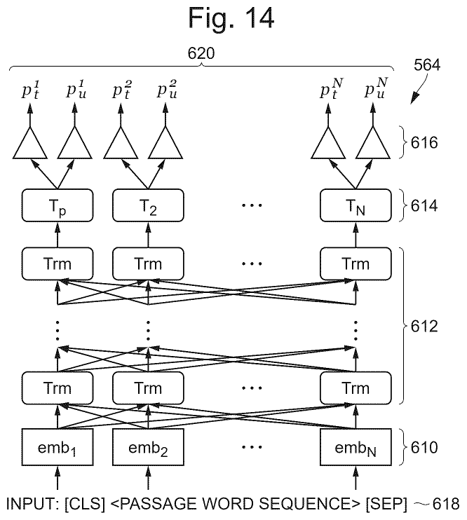

Cache data generating device 550 includes: a passage reading unit 562 for reading each of the passages from large-scale passage set 64; and a classification model 564 for classifying the words included in the read passages to those used for system utterance, those used for topic word sequences, and others. More specifically, of the words of input passages, classification model 564 adds the first label to the ones which are used for system utterance. Further, among the words used for system utterance, classification model 564 adds the second label, separate from the first label, to topic word sequences. Classification model 564 outputs the passage word sequences having labels attached in this manner. Here, these word sequences will be referred to as labeled passages 568. The configuration of classification model 564 will be described later with reference to FIG. 14.

Cache data generating device 550 further includes: a topic word sequence extracting unit 565 for extracting, from the labeled passages 568, a word sequence having the second label added, and outputting the word sequence as topic word sequence 566; and a system utterance part extracting unit 570 for extracting, from the labeled passages 568, a word sequence having the first label added, and outputting the word sequence as system utterance part word sequence 571. Specifically, by the topic word sequence extracting unit 565 and the system utterance part extracting unit 570, the topic word sequence part and the system utterance part of the object passage are extracted. Cache data generating device 550 further includes: a pre-trained system utterance generation model 572 receiving the system utterance part word sequence 571 as an input and generating a system utterance word sequence 574 from the system utterance part word sequence 571; and a cache data generation model 576 for generating cache data by concatenating topic word sequence 566 and system utterance word sequence 574 with a delimiter. The cache data generated by cache data generation model 576 is stored in a cache data storage device 578.

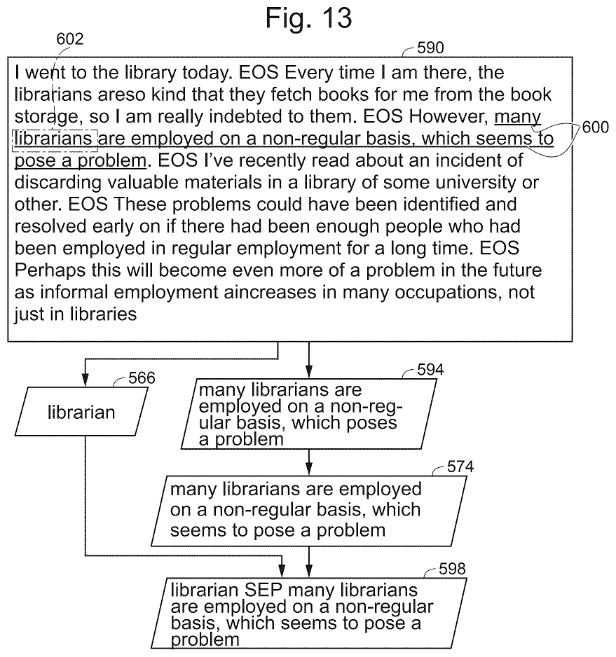

Referring to FIG. 13, cache data generating device 550 operates in the following manner. Assume that the classification model 564 of cache data generating device 550 received a passage 590. Classification model 564 shown in FIG. 12 adds the first label to word sequences 600 that correspond to the system utterance part, of the passage 590. Further, classification model 564 adds the second label to a word sequence 602 that corresponds to a topic word sequence, among the word sequences having the first label added. By extracting the word sequences having the first label added from the resulting passage word sequences, a system utterance part word sequence 594 is obtained. Similarly, by extracting the word sequence having the second label added from the passage word sequences, a topic word sequence 566 is obtained. By inputting the system utterance part word sequence 594 to the system utterance generation model 572 shown in FIG. 12, the system utterance word sequence 574 is obtained. System utterance generation model 572 is trained beforehand by using the training data such that when a system utterance part word sequence is received as an input, a system utterance is output based on the word sequence.

By concatenating the topic word sequence 566 and the system utterance word sequence 574 obtained in this manner with a delimiter (SEP), cache data 598 is obtained. By accumulating the cache data 598 and adding to dialogue processing cache data 82 shown in FIG. 1, the probability of a response utterance corresponding to user utterance 60 being a hit in dialogue processing cache data 82 becomes higher in dialogue system 50. As a result, load on dialogue engine 62 can be reduced, and the system utterance 90 can be output in a shorter time period. Further, system utterance word sequence 574 is generated not directly from passages 590 but from system utterance part word sequences 594 inferred as word sequences forming the system utterance. The system utterance part word sequence 594 is short, and the process for generating system utterance word sequence 574 is simple, as will be described later. As a result, the load for generating system utterance word sequence 574 is reduced.

### B Configuration of Classification Model 564

FIG. 14 shows an overall configuration of classification model 564. As classification model 564, BERT (Bidirectional Encoder Representation from Transformers) well known as a neural network model related to natural languages is used. Referring to FIG. 14, classification model 564 includes: an embedding layer 610 receiving an input word sequence 618 and converting it to a word vector sequence; a BERT transformer layer 612 having a plurality of transformer layers stacked, receiving at its input an output from the embedding layer 610; and an output layer 616 receiving a hidden vector sequence 614 of the last layer of BERT transformer layer 612 as an input, for outputting a probability vector 620 for determining the above-described labels from each of the vectors. As to the elements in output layer 616, first and second elements are prepared for each hidden vector. The first element is for outputting the probability pₜⁱ (N is the number of input words and i=1 to N) that the input word corresponding to the input hidden vector is the topic word sequence. The second element is for outputting the probability pᵤⁱ (i=1 to N) that the same input word is the word sequence of system utterance part.

The input word sequence 618 as an input to BERT transformer layer 612 is a passage word sequence having at the head a token “[CLS]” indicating that it is the head of input and at the tail a delimiter “[September]” added, as shown in the figure. In FIG. 14, “emb” indicates each element of the embedding layer, and “Trm” indicates the transformer layer.

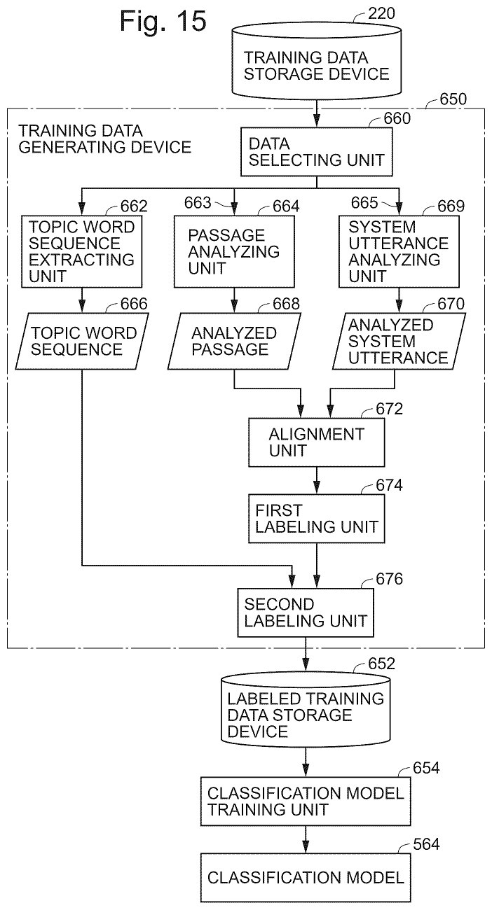

Classification model 564 is trained in the following manner. Referring to FIG. 15, for training classification model 564, the same data as stored in training data storage device 220 shown in FIG. 3 cannot be used, while training data generated for classification model 564 from the data stored in training data storage device 220 is used. The training data stored in training data storage device 220 is pairs of passage word sequence 260 and output word sequence 262 as correct answer data. Output word sequence 262 includes a topic word sequence, a system utterance word sequence, and a delimiter as a prescribed token separating these sequences, as shown in FIG. 4.

The training data generating system for the classification model 564 includes: training data storage device 220; a training data generating device 650 performing prescribed labeling on word sequences of the training data for training classification model 564, from the training data stored in training data storage device 220 and provides outputs; and a labeled training data storage device 652 for storing the outputs of training data generating device 650. The training data generating system further includes: a classification model training unit 654 reading the labeled training data stored in labeled training data storage device 652 for training classification model 564.

Training data generating device 650 includes: a data selecting unit 660 for successively reading training data from training data storage device 220; a topic word sequence extracting unit 662 for extracting topic word sequence 666 from the training data read by data selecting unit 660; and a passage analyzing unit 664 extracting a passage from the training data read by data selecting unit 660, performing morphological analysis of the passage, turning conjugated word (such as a verb) to the base form and outputting the result as analyzed passage 668. Training data generating device 650 further includes a system utterance analyzing unit 669 extracting a system utterance from the training data, performing morphological analysis of the system utterance, turning a conjugated word to the base form, and outputting the result as analyzed system utterance 670.

Training data generating device 650 further includes: an alignment unit 672 for aligning analyzed passage 668 and analyzed system utterance 670; a first labeling unit 674 for adding the first label to the word sequence of that portion of analyzed passage 668 aligned with the analyzed system utterance 670 by the alignment unit 672 which corresponds to the word sequence of the analyzed system utterance 670; and a second labeling unit 676, adding the second label to that word sequence which matches topic word sequence 666 among the parts having the first label added, in the analyzed passage 668 having the first label added by the first labeling unit 674, to generate labeled training data, and storing the training data in labeled training data storage device 652. The words having the first label added are used as positive examples of words of system utterance part, and the words not having the first label are used as negative examples. Further, the words having the second label added are used as the positive examples of the topic word sequences, and the words not having the second label are used as negative examples.

The analysis of word sequences by passage analyzing unit 664 and system utterance analyzing unit 669 is to ease alignment by alignment unit 672. For the alignment by alignment unit 672, known algorithm for alignment, such as Needleman-Wunsch Algorithm may be used.

Classification model training unit 654 trains classification model 564 such that it can predict, word by word, the probability pᵤⁱ that the word is the system utterance part, using the words having the first label as positive examples and the words not having the first label as negative examples. Classification model training unit 654 also trains classification model 564 such that it can predict, word by word, the probability pₜⁱ that the word is the topic word sequence, using the words having the second label as positive examples and the words not having the second label as negative examples.

Therefore, when a passage is input to classification model 564 trained by classification model training unit 654, for each word of the passage, the probability that the word is the word forming the system utterance and the probability that the word is the topic word sequence, can be obtained as the outputs of classification model 564. Of these, those that satisfy conditions, for example, that the probabilities are equal to or higher than the threshold value, can be predicted to be the word sequence forming the system utterance and the topic word sequence.

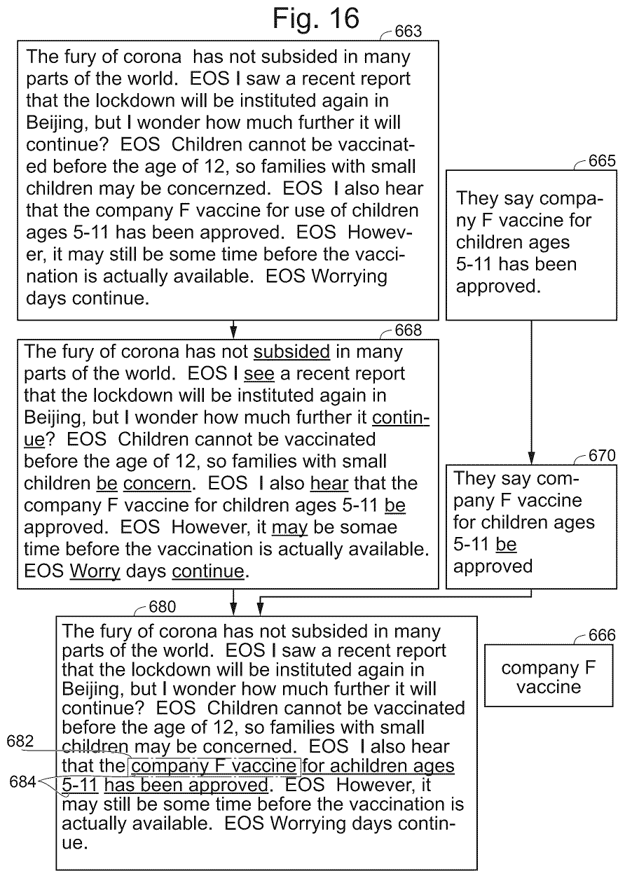

The process of generating training data by training data generating device 650 shown in FIG. 15 will be described with reference to FIG. 16. It is assumed that the training data read by data selecting unit 660 shown in FIG. 15 from training data storage device 220 includes a passage 663, a system utterance 665 and a topic word sequence 666. Passage 663 is input to passage analyzing unit 664. As a result of analysis by passage analyzing unit 664, conjugated words in passage 663 are replaced by base forms. Thus, passage analyzing unit 664 outputs an analyzed passage 668. Replaced conjugative words are indicated by underlines in the analyzed passage 668 of FIG. 16.

On the other hand, system utterance 665 is input to system utterance analyzing unit 673 shown in FIG. 15. As a result of analysis by system utterance analyzing unit 673, conjugated words in system utterance 665 are replaced by base forms. Replaced conjugative words are indicated by underlines in the analyzed system utterance 670 of FIG. 16. Thus, system utterance analyzing unit 673 outputs analyzed system utterance 670.

Analyzed passage 668 and analyzed system utterance 670 are both input to alignment unit 672 shown in FIG. 15. Alignment unit 672 aligns the analyzed passage 668 and analyzed system utterance 670. Since conjugative words in analyzed passage 668 and analyzed system utterance 670 are all replaced with base forms, alignment with high accuracy is possible. As a result of this alignment, from the word sequences in analyzed passage 668, a word sequence 684 that appears in analyzed system utterance 670 can be specified. To each of the words forming the word sequence 684, the first label is added. The passage 680 having the first labels added in this manner is input to the second labeling unit 676 shown in FIG. 15.

The second labeling unit 676 shown in FIG. 15 searches, from the words having the first label added in passage 680, for that word sequence which matches the topic word sequence 666. In the example shown in FIG. 16, a word sequence 682 in passage 680 matches topic word sequence 666. Therefore, the second label is added to word sequence 682. The passage 680 having the word sequences with the first and second labels thus added is stored in labeled training data storage device 652 as labeled training data. For training system utterance generation model 572 shown in FIG. 12, in labeled training data, the system utterances among the training data as the source of the data are also stored, as will be described later.

In this manner, the process of generating system utterance part word sequence 594 from passage 590 is basically the process of classifying word sequences. As compared with the example in which the entire cache data for the process is generated, the process load is small.

### C Training of System Utterance Generation Model 572

As the system utterance generation model 572 shown in FIG. 12, any model that can generate natural language sentences may be used. By way of example, a transformer-based one may be used. In the following, training of system utterance generation model 572 will be described.

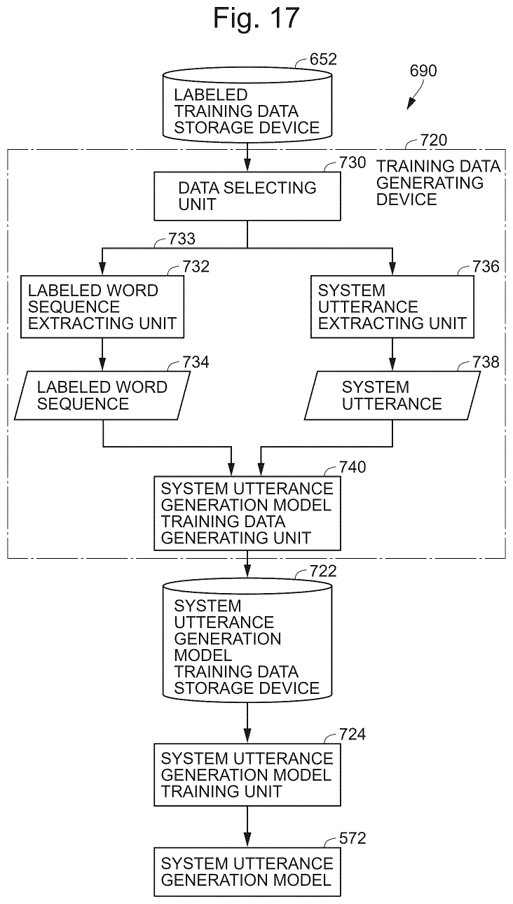

FIG. 17 shows a configuration of a training system 690 for training system utterance generation model 572. Referring to FIG. 17, training system 690 includes: a training data generating device 720 for generating training data for system utterance generation model 572 from the labeled training data stored in labeled training data storage device 652; and a system utterance generation model training data storage device 722 for storing the training data generated by training data generating device 720. Training system 690 further includes a system utterance generation model training unit 724 for training system utterance generation model 572 using the training data stored in system utterance generation model training data storage device 722.

Training data generating device 720 includes: a data selecting unit 730 for successively selecting and reading labeled training data (one example of which is passage 680 of FIG. 16) stored in labeled training data storage device 652; and a labeled word sequence extracting unit 732 for extracting a labeled word sequence 734 having the first label added, from the training data read by data selecting unit 730. When extracted word sequences are not continuous, labeled word sequence extracting unit 732 inserts a delimiter at each border between the word sequences. Training data generating device 720 further includes: a system utterance extracting unit 736 for extracting a system utterance 738 from the training data read by data selecting unit 730; and a system utterance generation model training data generating unit 740 that pairs labeled word sequence 734 and the system utterance 738 to form the training data for the system utterance generation model 572 and stores it in system utterance generation model training data storage device 722. In the training data, labeled word sequence 734 is the input and system utterance 738 is the correct answer data.

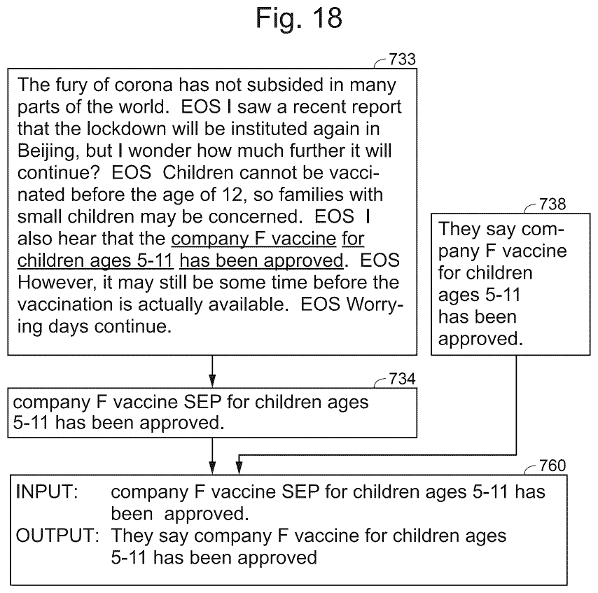

FIG. 18 shows the process how the training data 760 is generated from the labeled training data 733 read by data selecting unit 730 shown in FIG. 17. Referring to FIG. 18, by extracting labeled part (indicated as underlined part) of labeled training data 733, a labeled word sequence 734 is obtained. By combining the labeled word sequence 734 with the system utterance 738 extracted by system utterance extracting unit 736 shown in FIG. 17, training data 760 is formed. In training data 760, labeled word sequence 734 is an input and the word sequence of system utterance 738 is an output (correct answer data).

Training of system utterance generation model 572 by system utterance generation model training unit 724 is done by using the training data stored in system utterance generation model training data storage device 722. The training is done by error back-propagation as in the training of typical neural network. In the training data, labeled word sequence 734 and system utterance 738 have very similar word sequences. Therefore, training of system utterance generation model training unit 724 and the generation of system utterance by system utterance generation model training unit 724 can both be executed with reduced load.

As described above, by the present embodiment, the load on the process for generating system utterance part word sequence 594 from the passage 590 such as shown in FIG. 13 and the load on the process for generating system utterance word sequence 574 from system utterance part word sequence 594 can both be reduced. Therefore, as compared with the example in which the system utterance is directly generated from the passage 590, process load can be made smaller. As a result, by the cache data generating device 550 in accordance with the present embodiment, a large amount of cache data can be generated in a shorter time period.

### 6. Sixth Embodiment

In the embodiments above, one record of cache data is generated from one passage. This method, however, is inefficient even when there are a large number of passages. In the sixth embodiment, if possible, a plurality of records of cache data is generated from one passage. Further, in the embodiments above, the key word sequence is only the topic word sequence. It is noted that user utterances including the same topic word sequence may have various forms. Therefore, in the sixth embodiment, not the topic word sequence but user utterance itself is employed as the key word sequence.

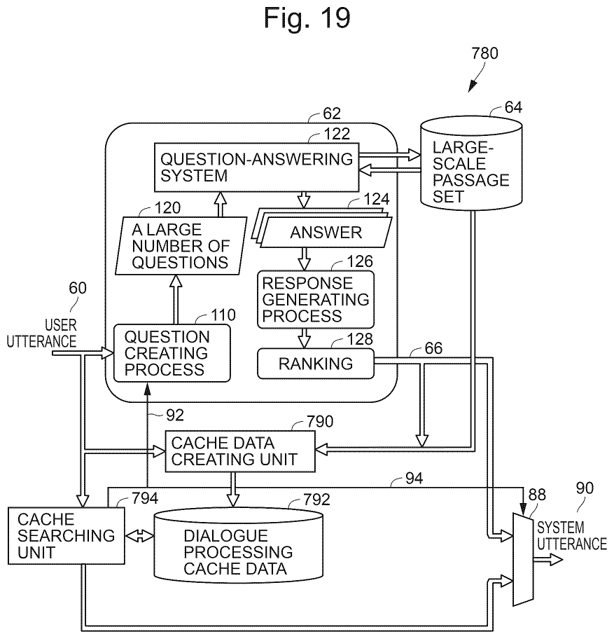

FIG. 19 shows a schematic configuration of a dialogue device 780 using the cache data in accordance with the sixth embodiment. Dialogue device 780 is different from the dialogue system 50 of the prior art shown in FIG. 1 in that it includes dialogue processing cache data 792 storing cache data in such a format that allows retrieving of a system utterance using the user utterance itself as a key, different from dialogue processing cache data 82 of FIG. 1. In accordance with this change, dialogue device 780 includes, in place of cache data creating unit 80 shown in FIG. 1, a cache data creating unit 790 for generating cache data from user utterance 60 and system response 66. Further, dialogue device 780 does not include topic extracting unit 68 shown in FIG. 1. Further, dialogue device 780 differs from dialogue system 50 in that it includes, in place of cache searching unit 84, a cache searching unit 794 that searches dialogue processing cache data 792 using user utterance 60 as a key. Cache searching unit 794 has a function of reading, when there is any cache data that has the same key word sequence as the user utterance 60, the word sequence of its system utterance.

Cache searching unit 794 issues a notice 92 indicating whether or not cache data is found in dialogue processing cache data 792, to dialogue engine 62. Further, cache searching unit 794 also applies a control signal 94 to dialogue engine 62, which signal controls selecting unit 88 to select the first input when cache data is not found and the second input when it is found. As a result, when there is any cache data that has the key word sequence matching the user utterance 60, the system utterance of the cache data is output as system utterance 90. If there is no such cache data, system response 66 generated by dialogue engine 62 is output as system utterance 90.

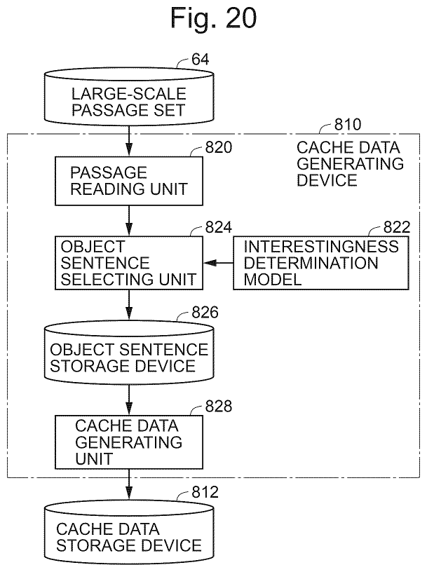

FIG. 20 shows a schematic configuration of a cache data generating device 810, for generating, from each of a large number of passages stored in large-scale passage set 64, one or more cache data and storing the cache data in a cache data storage device 812. Here, one record of cache data is obtained by concatenating a key word sequence that corresponds to the user utterance 60, a delimiter, and the system utterance in response to the user utterance.

Referring to FIG. 20, cache data generating device 810 includes: a passage reading unit 820 for successively reading passages from large-scale passage set 64; an interestingness determination model 822; and an object sentence selecting unit 824 that outputs as object sentence or sentences for cache generation, one or more sentences of which score determined by interestingness determination model 822 is equal to or higher than a threshold value, from the passages read by passage reading unit 820, using interestingness determination model 822.

Different from interestingness determination model 158 shown in FIG. 2 and the like, interestingness determination model 822 is a BERT-based model using the sentence as an object of determination and all the sentences preceding this sentence in the passage (hereinafter, these sentences will be referred to as “context” of the object sentence) as inputs, to output a score indicating how interesting the object sentence is as compared with the context.

Cache data generating device 810 further includes: an object sentence storage device 826 for storing object sentences selected by object sentence selecting unit 824; and a cache data generating unit 828 for generating cache data from each of the object sentences stored in object sentence storage device 826.

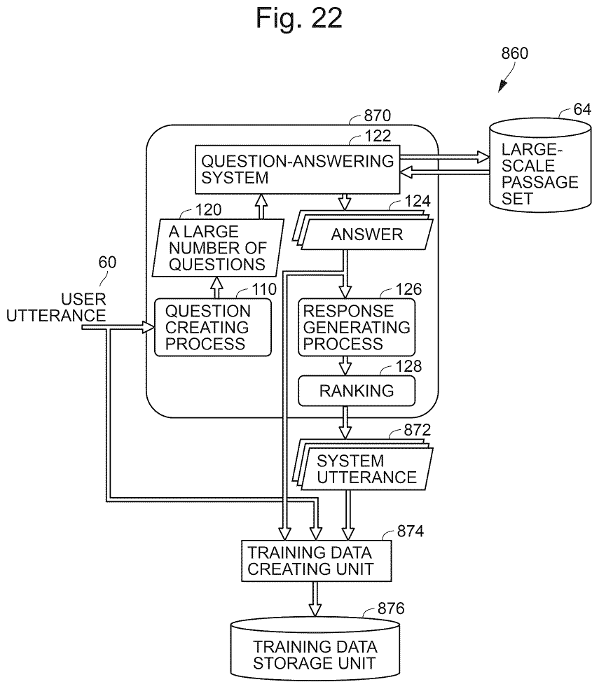

Cache data generating unit 828 is realized by using a neural network model using a transformer architecture. The transformer is known to have exhibited, particularly in the natural language processing, remarkably higher performance than preceding neural networks. The method of training the neural network will be described with reference to FIGS. 22 to 26.

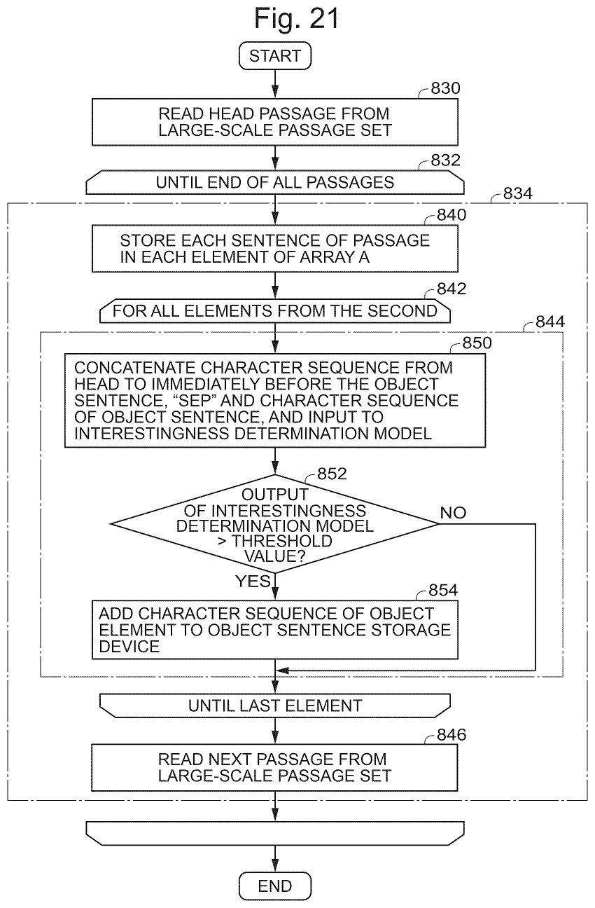

FIG. 21 is a flowchart showing a control structure of a computer program for realizing selection of object sentence by passage reading unit 820 and object sentence selecting unit 824. Referring to FIG. 21, the program includes: a step 830 of reading a head passage from large-scale passage set 64; and a step 832 of repeating step 834 until all passages are read from large-scale passage set 64.

Step 834 includes: a step 840 of separating the passage as the object of processing at each sentence separation position and storing the separated result as elements of array A, respectively; a step 842 of executing the following step 844 on all elements from the second one (elements of which suffix of array A is 1 ore larger) of array A; and a step 846, responsive to the end of step 842, of reading the next passage from large-scale passage set 64 and ending step 834. If there is no passage to be read next at step 846, step 832 ends.

Step 844 includes: a step 850 of coupling a character sequence obtained by concatenating all the elements preceding the element as the object of processing of the array, a token “SEP” as the delimiter, and the elements of character sequence as the object of processing, and inputting the result to interestingness determination model 822; a step 852 of determining whether the score output for the input by interestingness determination model 822 is larger than a prescribed threshold value; and a step 854 executed if the determination at step 852 is positive, of selecting the element as the object of processing and storing in object sentence storage device 826 (FIG. 20). If the determination at step 852 is negative, the element as the object of processing is not used as the object sentence.

By running this program on a computer, sentences of which interestingness is equal to or larger than the threshold value when compared with the context are selected from each of the passages. The number of sentences obtained from a passage may be 0, or 1 or more. Though it depends on the number of sentences included in each passage, it is expected that the number of sentences eventually obtained would be far larger than the number of passages stored in large-scale passage set 64.

In the present embodiment, only the sentences having the interestingness score equal to or higher than the threshold value when compared with the context are selected as the object sentences. Therefore, the first sentence of each passage is not selected. The present invention, however, is not limited to such an embodiment. It is also possible to select every sentence of each passage as the object sentence. Further, in the present embodiment, object sentence selecting unit 824 selects sentences one by one. The present invention, however, is not limited to such an embodiment. For example, sentences may be selected not one by one but two by two or more, or a unit smaller than one sentence, such as a word sequence, may be selected. Further, a plurality of different length may be used as the length of selection or length of word sequence.

FIG. 22 shows a schematic configuration of training data generating device 860 for generating training data for training the neural network realizing cache data generating unit 828 shown in FIG. 20. Training data generating device 860 includes: large-scale passage set 64; and a dialogue engine 870 responsive to user utterance 60 for generating system utterance 872 by the same method as dialogue engine 62 shown in FIG. 1, using large-scale passage set 64.

Dialogue engine 870 has the same configuration as dialogue engine 62 shown in FIG. 1. Different from dialogue engine 62, however, dialogue engine 870 outputs, not only the response regarded as the most appropriate response to user utterance 60 obtained through ranking 128 but also a plurality of responses satisfying a prescribed condition, as a plurality of system utterances 872. By way of example, in ranking 128, interestingness of each response as the response to question 120 or user utterance 60 is determined, and the responses may be filtered using the results. By doing this, a plurality of pieces of training data can be generated from one user utterance. 60. As a result, formation of training data for cache data generation can be done more efficiently. In the following, a cache data record will be simply referred to as a cache record.

Training data generating device 860 further includes: a training data creating unit 874 for creating the training data by concatenating one of the plurality of answers 124 generated in dialogue engine 870 in response to user utterance 60 and system utterance 872 generated from the selected answer 124 with a delimiter; and a training data storage unit 876 for storing the training data output from training data creating unit 874.

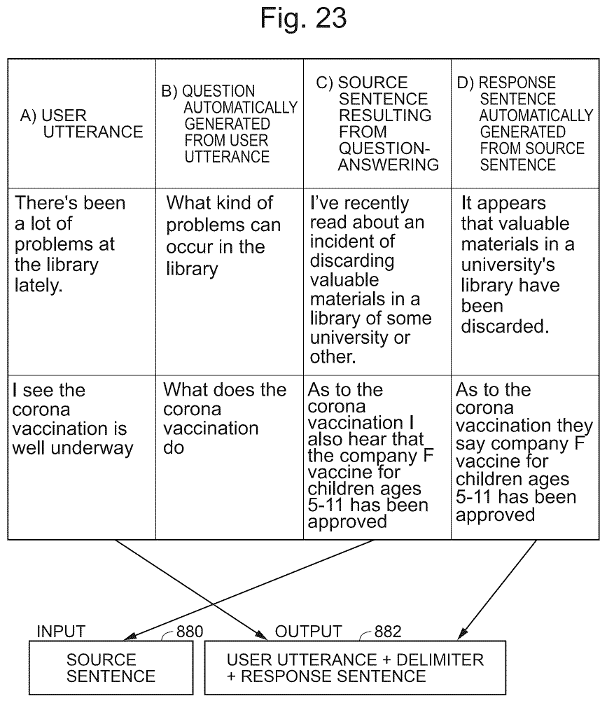

FIG. 23 shows an example of the training data generated in this manner. The upper part of FIG. 23 shows a combination of user utterance 60, a question automatically generated by question creating process 110 from the user utterance 60, an answer 124 as one of the plurality of answers generated by question-answering system 122 to the question, and a response sentence (system utterance) automatically generated from answer 124. Since answer 124 is the source of automatically generated response sentence, it is referred to as “source sentence” here.

Of these sentences (word sequences), in the present embodiment, the source sentence (answer to the question) is used as input 880, and a word sequence 882 formed by concatenating user utterance 60, a delimiter and a response sentence (system utterance) in this order is used as an output (correct answer data), which are combined to generate a record of training data.

By training the neural network using the training data including a large number of such records, cache data generating unit 828 shown in FIG. 20 is realized.

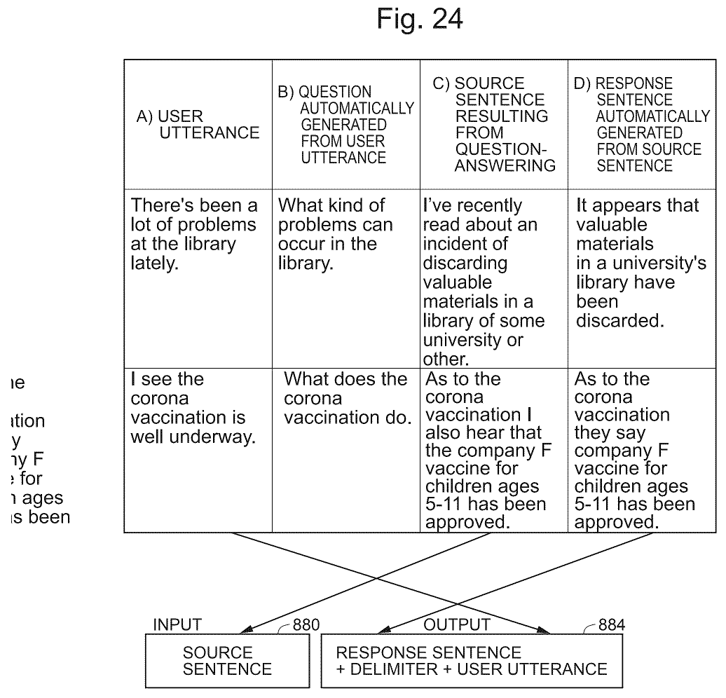

The combination of word sequences when the training data is generated is not limited to the one shown in FIG. 23. By way of example, a combination such as shown in FIG. 24 may be used.

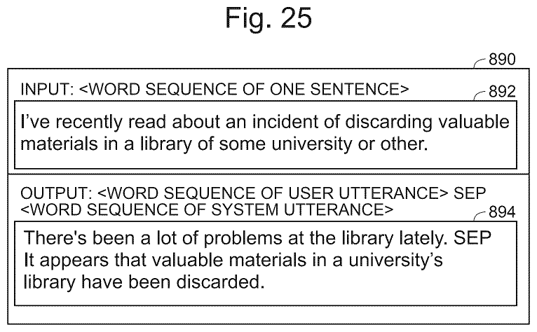

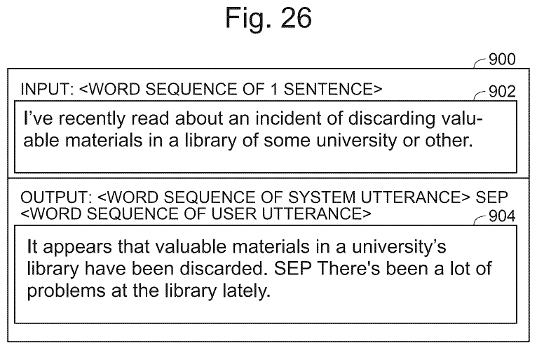

In the example shown in FIG. 24, similar to the example of FIG. 23, the source sentence obtained for the question is used as input 880. In FIG. 24, however, a word sequence 884 obtained by concatenating the response sentence (system utterance), a delimiter and the user utterance in this order is used as the output (correct answer data), which is combined to generate a record of training data. FIG. 25 shows an example of training record 890 formed in accordance with the example of FIG. 23, and FIG. 26 shows an example of training record 900 formed in accordance with the example of FIG. 24. Training records 890 and 900 are obtained from the source sentence and the response sentence derived from the same utterance.

Referring to FIG. 25, training record 890 includes an input 892 and an output 894. On the other hand, referring to FIG. 26, training record 900 includes an input 902 and an output 904. Input 892 is the same as input 902. In outputs 894 and 904, however, the word sequences before and after the delimiter are switched. Specifically, in FIG. 25, the correct answer data has the order of user utterance→system utterance, while in FIG. 26, the order is system utterance→user utterance.

It is possible to train cache data generating unit 828 using either the form of FIG. 25 or of FIG. 26. Specifically, it is possible to train cache data generating unit 828 to generate cache data consisting of the combination of user utterance and system utterance from one sentence. The resulting cache data generating unit 828, however, may have different effects depending on which of the training data was used. Here, an experiment was conducted to evaluate the results.

### Experiment

The numbers of samples used in the entire experiment were as follows: 178,374 training data; 9,272 development data; 27,037 test data. Of these, the numbers of samples having the interestingness determination score of 0.5 or higher were: 61,312 training data; 3,173 development data and 9,215 test data.

In the experiment, a transformer pre-trained as the cache data generating unit 828 was prepared. The transformer includes a combination of encoder/decoder, and the transformer used in the experiment had an encoder of 24 layers and a decoder of one layer. Parameters of embedding layers of the encoder and the decoder were commonly shared. The transformer was fine-tuned. Search parameters for the fine tuning were as follows.

The epoch number of training was {1, 2, 3, 5, 10, 15, 20, 25, 30} for the search. The learning rate was 3e-5, and the batch size was 32.

As to the evaluation metrics, (1) ROUGE-1, ROUGE-2, and ROUGE-3 and (2) the average of interestingness scores obtained by inputting generated pairs of user utterance and system utterance to the interestingness determiner, are used, and best parameters for each of the two evaluation metrices were determined.

Further, experiments were conducted separately for when only those sentences in each passage which had the interestingness determination score equal to or higher than the threshold value (0.5) were used, by utilizing interestingness determination model 822 as in the embodiment above, and when all sentences obtained from each passage were used.

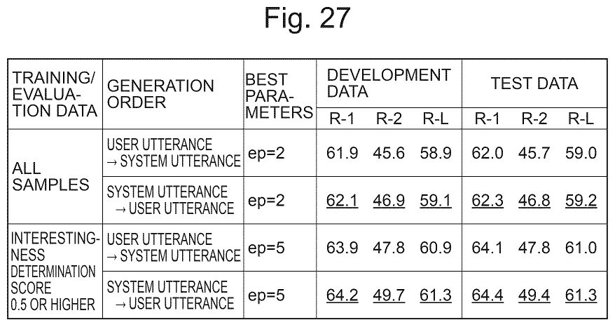

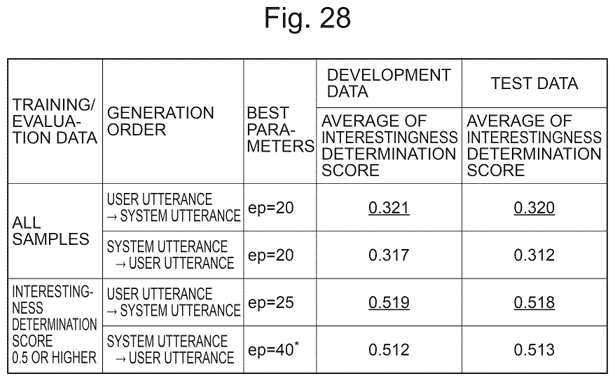

Results are shown in FIGS. 27 and 28. FIG. 27 shows the results when ROUGE-{1, 2, L} was used as the evaluation metric. FIG. 28 shows the results when the average of interestingness determination scores was used as the evaluation metric. Both in FIGS. 27 and 28, of the evaluation when the order was user utterance→system utterance and the evaluation when the order was system utterance→user utterance, the ones having higher evaluation are underlined.

Referring to FIG. 27, when we compare the examples using the combination of user utterance→system utterance and the examples using the combination of system utterance→user utterance, it can be seen that the latter always have higher scores.

Referring to FIG. 28, when the average of interestingness determination scores was used as the evaluation metric, both when all the sentences were used and when only those having the interestingness scores of 0.5 or higher were used, those trained with the order of user utterance→system utterance had higher scores, different from the example of FIG. 27. It is noted that the best parameter at the lowermost row of FIG. 28 is 40. As described above, the upper limit of epoch search range was 30. With this setting, however, the average score attained the highest when the epoch number was 30. Therefore, additional experiment was conducted with epoch number={35, 40, 45, 50} to determine the best parameter.

From the results of experiments, it seems that when the epoch number is small, sentence generation often fails when an unknown word is replaced by a sign. On the other hand, if the average of interestingness scores is used as the evaluation metric, the epoch number is large and such generation failure is relatively rare. From these results, we may conclude that it is desirable to use the best parameter obtained when the average of interestingness determination scores was used as the evaluation metric.

### 7. Seventh Embodiment

In the sixth embodiment, as shown in FIGS. 25 and 26, the training data was generated by the combinations of user utterances, source sentences and system utterances obtained by the dialogue engine 870 shown in FIG. 22. The present invention, however, is not limited to such an embodiment. The question as the origin of the source sentence output from dialogue engine 870 may be added to the training data.

The seventh embodiment is directed to this approach.

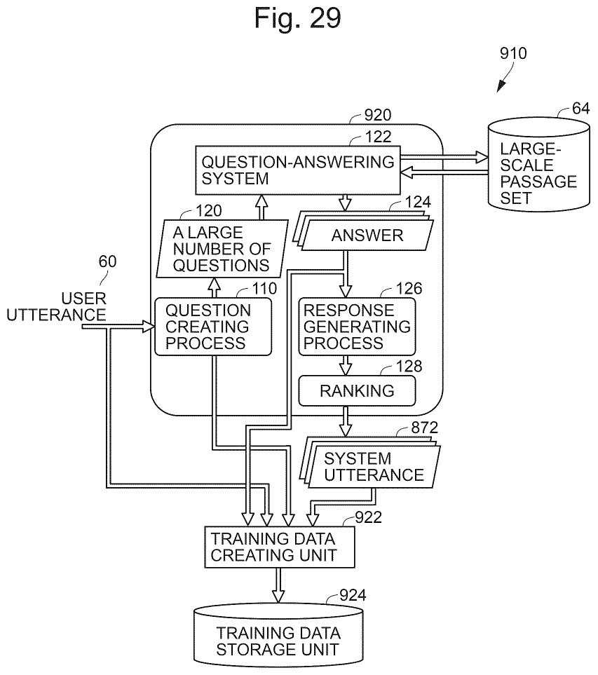

Referring to FIG. 29, a training data generating device 910 in accordance with the seventh embodiment includes: a dialogue engine 920 having the same configuration as dialogue engine 870 shown in FIG. 22; a training data creating unit 922 for generating training data by combining user utterance 60, one of the questions 120 generated by question creating process 110 for the user utterance 60, an answer 124 output by question-answering system 122 to the question, and system utterance 872 generated by response generating process 126 using the answer 124 as the source sentence; and a training data storage unit 924 for storing the training data generated by the training data creating unit 922.

Though not shown, in the present embodiment, the training data generated by training data creating unit 922 has the answer 124 as an input, and the user utterance 60, a delimiter, the question 120, a delimiter and the system utterance 872 coupled in this order as the output (correct answer data). Specifically, the cache data generated by the cache data generation model trained by using the training data as such come to include not only the sets of user utterance and system utterance but also the information of what question was issued for the user utterance that results in the system utterance as the answer. By storing such cache data, the possibility of outputting a system utterance to a user utterance from the cache increases and, in addition, information as a certain support for the system utterance can be obtained from the cache.

### 8. Eighth Embodiment

The first to seventh embodiments are all used for idle conversation or chat. The present invention, however, can be applied also to a system, such as a question-answering system providing an answer to a question.

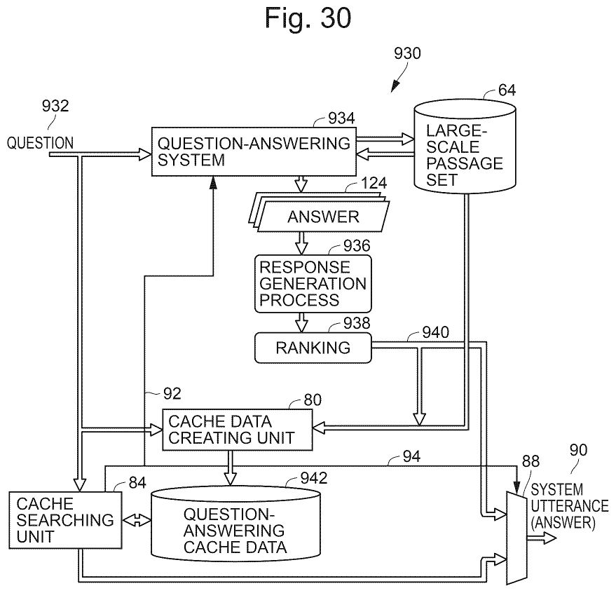

FIG. 30 is a block diagram of a question-answering system 930 that can use cache data, in accordance with the eighth embodiment. The question-answering system 930 shown in FIG. 30 has a configuration very similar to the dialogue system 50 shown in FIG. 1. Question-answering system 930 differs from dialogue system 50 in that: what is input is not a general user utterance 60 but a question 932; in place of question-answering system 122, it includes a question-answering system 934 that switches operation in response to a notice 92 from cache searching unit 84; and in place of response generating process 126 and ranking 128, it includes a response generation process 936 and ranking 938 that operate to output a system utterance 90 appropriate as an answer to the question. Question-answering system 930 differs from dialogue system 50 also in that, in place of dialogue processing cache data 82 of FIG. 1, it includes question-answering cache 942. It is noted, however, that question-answering cache 942 is substantially the same as dialogue processing cache data 82, except that the data items stored therein are different.

The operation of question-answering system 930 is substantially the same as dialogue system 50. Specifically, if cache data corresponding to the question 932 does not exist in question-answering cache 942, question-answering system 930 operates in the following manner.

Cache searching unit 84 searches if there is any cache record having the same key word sequence as question 932 in question-answering cache 942. Here, there is no such cache record. Therefore, cache searching unit 84 transmits a notice 92 to question-answering system 934 to conduct normal operation. Further, cache searching unit 84 transmits a control signal 94 to selecting unit 88 to select system response 940.

In response to question 932, question-answering system 934 outputs a plurality of answers 124 including descriptions appropriate as answers to question 932, from the passages in large-scale passage set 64. Response generation process 936 appropriately processes each of these answers to be an answer to question 932, and thus generates candidates of system response. Ranking 938 selects the most appropriate system response 940 to the question 932 from the system response candidates, and applies it to selecting unit 88. Generally, selecting unit 88 selects system response 940 and outputs it as system utterance 90.

Here, to cache data creating unit 80, question 932, system response 940 and the original passage of system response 940 are applied. Cache data creating unit 80 couples question 932 and the system response with a delimiter, and further adds the original passage, to generate a cache record, which is stored in question-answering cache 942. Basically, the format of each record in question-answering cache 942 is the same as the output word sequence 262 of the training record 250 shown in FIG. 4. As in the first embodiment, however, the cache record additionally stores the original passage from which the word sequence of system utterance is obtained.

On the other hand, if there is a cache record having the question 932 as the key word sequence, question-answering system 930 operates in the following manner.

Cache searching unit 84 transmits a notice 92 not to operate, to question-answering system 934. Cache searching unit 84 reads the corresponding cache record from question-answering cache 942, and outputs the response sentence included in the record to selecting unit 88. Cache searching unit 84 further transmits a control signal 94 to selecting unit 88 to select the output of cache searching unit 84. Thus, selecting unit 88 selects the output of cache searching unit 84 and outputs it as system utterance 90. Question-answering system 934 does not operate.

It is desirable that question-answering cache 942 can be generated efficiently also in question-answering system 930. The eighth embodiment is for this purpose.

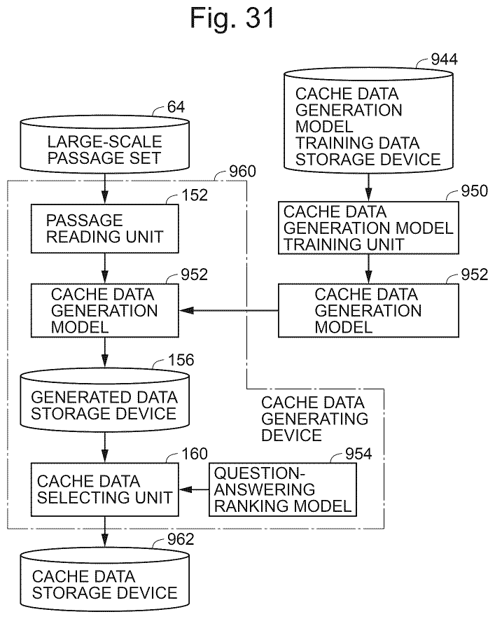

FIG. 31 shows a schematic configuration of cache data generating device 960 for generating cache data for the question-answering system 930 in accordance with the present embodiment.

Referring to FIG. 31, cache data generating device 960 includes: a passage reading unit 152 for reading each of the passages in large-scale passage set 64; and a cache data generation model 952 trained in advance for generating, from each passage read by passage reading unit 152, the above-described record of cache data. Training of cache data generation model 952 will be described later.

Cache data generating device 960 further includes: a generated data storage device 156 for storing each of the records output from cache data generation model 952; and a cache data selecting unit 160, applying a question-answering ranking model 954 to each of the records stored in generated data storage device 156 to calculate its score, and for outputting only the records having the scores equal to or higher than a prescribed threshold value. Question-answering ranking model 954 is a model similar to interestingness determination model 158 shown in FIG. 2. It is noted, however, that this model is trained beforehand to rank question-answer pairs from the viewpoint of appropriateness of system utterance (answer) to the question 932, rather than the interestingness of system utterance to the user utterance 60.

In the present embodiment, the output of cache data selecting unit 160 is accumulated in cache data storage device 962. By copying (adding) the cache records accumulated in cache data storage device 962 to question-answering cache 942 shown in FIG. 30, the probability that an answer to the question hits in question-answering cache 942 in question-answering system 930 becomes higher.

As shown in FIG. 31, training of cache data generation model 952 is done by cache data generation model training unit 950 using the training data stored in cache data generation model training data storage device 944. The training itself by cache data generation model training unit 950 is not at all different from the conventional training. In the present embodiment, what is challenging is how to efficiently generate the training data for cache data generation model 952.

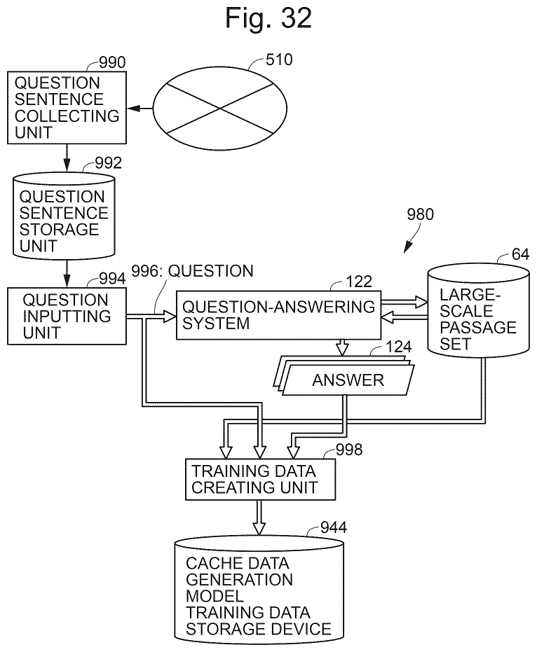

FIG. 32 shows a schematic configuration of training data generation system 980. Referring to FIG. 32, the configuration of training data generation system 980 is similar to that of question-answering system 930. Specifically, training data generation system 980 includes: a question-answering system 122 receiving a question 996 and outputting a plurality of answers 124 from large-scale passage set 64; and a training data creating unit 998, for generating, by combining the question 996, the answer 124 and the original passage used for generating the answer 124 among the passages stored in large-scale passage set 64, the training data of the above-described format and storing the training data in cache data generation model training data storage device 944.

Training data generation system 980 further includes: a question sentence collecting unit 990 for collecting question sentences from various sites on the Internet 510; a question sentence storage unit 992 for storing the question sentences collected by question sentence collecting unit 990; and a question inputting unit 994 for inputting each of the questions stored in question sentence storage unit 992 as question 996 to question-answering system 122.

Though not shown, in the present embodiment, the training data formed by training data creating unit 998 has the original passage from large-scale passage set 64 as an input and the combination of question 996+a delimiter+answer 124 coupled in this order as an output (correct answer data). Specifically, the cache data generation model trained by using the training data comes to include, when a passage is given, a question to which the word sequence included in the passage forms an answer, a delimiter, and the word sequence to be the answer. In order that the cache record generated in this manner comes to have the same format as the cache record generated by the operation of question-answering system 930 shown in FIG. 30, it is more preferable to add the original passage (or its identifier) to the cache record.

By the embodiment, system load for generating a system utterance appropriate as an answer to a question, rather than the simple chat, can be reduced. There are an enormous number of question sentences on the Internet 510. Therefore, question sentence collecting unit 990 shown in FIG. 32 can collect an enormous number of question sentences from the Internet 510. As a result, by inputting these question sentences to training data generation system 980, the training data for the cache data generation model 952 shown in FIG. 31 can be generated in large volume. As a result, a large amount of cache data can be generated by cache data generation model 952. Further, there is an additional effect that the accuracy of question-answering can be improved. The computational load can be reduced from the load for generating cache data individually by question-answering system 930 shown in FIG. 30. Thus, highly accurate cache data can be generated with high efficiency.

### 9. Computer Implementation

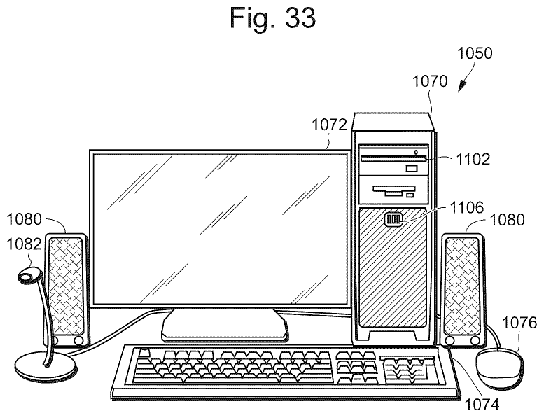

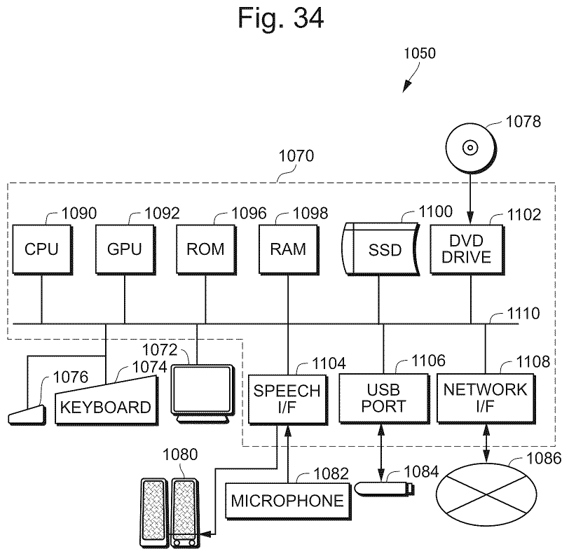

FIG. 33 shows an appearance of a computer system operating as the cache data generating device, various model training devices, and the training data generating devices therefor, in accordance with the embodiments above. FIG. 34 is a hardware block diagram of the computer system shown in FIG. 33. Dialogue device 780 shown in FIG. 19, training data generating device 860 shown in FIG. 22 and training data generating device 910 shown in FIG. 29 can also be realized by the computer system having the same configuration as those shown in FIGS. 33 and 34. Here, the configuration of computer system operating as cache data generating device 140 shown in FIG. 2 will only be described, and details of the computer system implementing other devices will not be repeated.

Referring to FIG. 33, the computer system 1050 includes: a computer 1070 having a DVD (Digital Versatile Disc) drive 1102; and a keyboard 1074, a mouse 1076 and a monitor 1072, all connected to computer 1070 for interaction with the user. These are examples of equipment, and any other general hardware and software (for example, a touch-panel, voice input, pointing device and so on) allowing user interaction may be used.

Referring to FIG. 34, computer 1070 includes, in addition to DVD drive 1102, a CPU (Central Processing Unit) 1090, a GPU (Graphics Processing Unit) 1092, and a bus 1110 connected to CPU 1090, GPU 1092, and DVD drive 1102. Computer 1070 further includes: a ROM (Read-Only Memory) 1096 connected to bus 1110 for storing a boot up program and the like of computer 1070, a RAM (Random Access Memory) 1098 connected to bus 1110, for storing program instructions, a system program and work data, and an SSD (Solid State Drive) 1100, which is a non-volatile memory connected to bus 1110. SSD 1100 is for storing programs executed by CPU 1090 and GPU 1092, data used by the programs executed by CPU 1090 and GPU 1092 and so on.

Computer 1070 further includes a network I/F (Interface) 1108 providing connection to a network 1086 (for example, Internet 510 shown in FIG. 11) allowing communication with other terminals; and a USB (Universal Serial Bus) port 1106 to which a USB memory 1084 may be detachably attached, providing communication with USB memory 1084 and different units in computer 1070.

Computer 1070 further includes: a speech I/F 1104 connected to a microphone 1082, a speaker 1080 and bus 1110, reading out a speech signal, a video signal and text data generated by CPU 1090 and stored in RAM 1098 or SSD 1100 under the control of CPU 1090, to convert it into an analog signal, amplify it, and drive speaker 1080, or digitizing an analog speech signal from microphone 1082 and storing it in addresses in RAM 1098 or in SSD 1100 specified by CPU 1090. These are necessary for speech dialogue with the user.

In the embodiments described above, programs realizing various functions of the devices are stored for example, in SSD 1100, RAM 1098, DVD 1078 or USB memory 1084 shown in FIG. 34, or in a storage medium of an external device, not shown, connected through network I/F 1108 and network 1086. Typically, the data and parameters are written from the outside to SSD 1100, for example, and at the time of execution by computer 1070, loaded into RAM 1098.

Computer programs causing the computer system to operate to realize functions of the various devices of the embodiments above and its various components are stored in DVD 1078 loaded to DVD drive 1102, and transferred from DVD drive 1102 to SSD 1100. Alternatively, USB memory 1084 storing the programs is attached to USB port 1106, and the programs may be transferred to SSD 1100. Alternatively, the programs may be transmitted through network 1086 to computer 1070 and stored in SSD 1100.

At the time of execution, the programs will be loaded into RAM 1098. Naturally, source programs may be input using keyboard 1074, monitor 1072 and mouse 1076, and the compiled object programs may be stored in SSD 1100. When a script language is used, scripts input through keyboard 1074 or the like may be stored in SSD 1100. For a program operating on a virtual machine, it is necessary to install programs that function as a virtual machine in computer 1070 beforehand. For speech recognition and speech synthesis, trained neural networks may be used. As the model generation units of the embodiments described above, a trained neural network may be used, or a neural network may be trained using computer system 1050 as a training device.

CPU 1090 fetches an instruction from RAM 1098 at an address indicated by a register therein (not shown) referred to as a program counter, interprets the instruction, reads data necessary to execute the instruction from RAM 1098, SSD 1100 or from other device in accordance with an address specified by the instruction, and executes a process designated by the instruction. CPU 1090 stores the resultant data at an address designated by the program, of RAM 1098, SSD 1100, register in CPU 1090 and so on. Depending on the address, the result may be output as a speech signal from the computer. At this time, the value of program counter is also updated by the program. The computer programs may be directly loaded into RAM 1098 from DVD 1078, USB memory 1084 or through the network 1086. Of the programs executed by CPU 1090, some tasks (mainly numerical calculation) may be dispatched to GPU 1092 by an instruction included in the programs or in accordance with a result of analysis during execution of the instructions by CPU 1090.

The programs realizing the functions of various units in accordance with the embodiments above by computer 1070 may include a plurality of instructions described and arranged to cause computer 1070 to operate to realize these functions. Some of the basic functions necessary to execute the instruction are provided by the operating system (OS) running on computer 1070, by third-party programs, or by modules of various tool kits installed in computer 1070. Therefore, the programs may not necessarily include all of the functions necessary to realize the system and method in accordance with the present embodiment. The programs have only to include instructions to realize the functions of the above-described various devices or their components by statically linking or dynamically calling appropriate functions or appropriate “program tool kits” in a manner controlled to attain desired results. The operation of computer 1070 for this purpose is well known and, therefore, description thereof will not be repeated here.

It is noted that GPU 1092 is capable of parallel processing and capable of executing a huge amount of calculation accompanying machine learning simultaneously in parallel or in a pipe-line manner. By way of example, parallel computational elements found in the programs during compilation of the programs or parallel computational elements found during execution of the programs may be dispatched as needed from CPU 1090 to GPU 1092 and executed, and the result is returned to CPU 1090 directly or through a prescribed address of RAM 1098 and input to a prescribed variable in the program.

Further, the devices in accordance with the embodiments above are realized by independent computers as shown in FIGS. 33 and 34. The present invention, however, is not limited to such embodiments. By way of example, various units of the embodiments above may be arranged distributed on one or more computers, and through mutual communication, unified operation may be realized as a whole. Alternatively, a virtual system may be built on one or more computers and the above-described program may be executed on the OS running on the virtual system, or the above-described system may be built on the so-called cloud, so that the cache data as described above can be generated by accessing to it from anywhere on the Internet.

As described above, by the present invention, it is possible to generate cache data for the dialogue system from a large number of passages included in large-scale passage set 64. By adding the generated cache data to the cache data of the dialogue system, a system utterance as a response to user utterance 60 comes to be found in the cache, and response to the user can be provided without operating the dialogue engine. As a result, the utterance data generating device that enable efficient generation of cache data for the dialogue device, the dialogue device and the method of generating a generation model, can be provided.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCE SIGNS LIST

50 dialogue system
60 user utterance
62, 870, 920 dialogue engine
64 large-scale passage set
66, 90, 665, 738, 872 system utterance
80, 790 cache data creating unit
82, 792 dialogue processing cache data
122, 930, 934 question-answering system
140, 270, 370, 550, 810, 960 cache data generating device
152, 562, 820 passage reading unit
154, 528, 576, 952 cache data generation model
158, 212, 822 interestingness determination model
160, 290 cache data selecting unit
162, 292, 578, 812, 962 cache data storage device
200, 950 cache data generation model training unit
216 object cache data storage device
218, 522 training data generating unit
220, 524 training data storage device
222, 526 model training unit
288, 388 cache data candidate storage device
310, 340, 410, 440, 760 training data
320, 420 passage word sequence
322, 452, 566, 666 topic word sequence
350, 450, 600, 602, 682, 684, 882, 884 word sequence
352, 422, 574 system utterance word sequence
382 system utterance generating unit
384 system utterance-added passage storage device
500 model training system
502 cache data generation model training device
512 dialogue data collecting unit
514 dialogue data storage device
518 related passage selecting unit
520 object data storage device
564 classification model
565,662 topic word sequence extracting unit
570 system utterance part extracting unit
571, 594 system utterance part word sequence
572 system utterance generation model
598 cache data
650, 720, 860, 910 training data generating device
652 labeled training data storage device
654 classification model training unit
690 training system
724 system utterance generation model training unit
740 system utterance generation model training data generating unit
780 dialogue device
828 cache data generating unit
874, 922, 998 training data creating unit
954 question-answering ranking model

1. An utterance data generating device for a dialogue device, comprising:
a response utterance generating means for generating, from each of a plurality of passages, a word sequence pair including an utterance word sequence forming a response utterance to an input utterance and a key word sequence to be a key for retrieving the utterance word sequence; and
a word sequence pair storage device for storing the word sequence pair generated by the response utterance generating means in a manner allowing reading at least using the key word sequence as a key.

2. The utterance data generating device according to claim 1, wherein the response utterance generating means includes a trained word sequence generation model, trained to generate, when a passage is given, a word sequence including a key word sequence and an utterance word sequence separated from each other by a prescribed separated tokens, from the passage.

3. The utterance data generating device according to claim 1, wherein
the response utterance generating means includes
a first word sequence generation model pre-trained to generate, when a passage is given, an utterance word sequence, and
a second word sequence generation model pre-trained to generate, when a passage and an utterance word sequence are given, the key word sequence.

4. The utterance data generating device according to claim 1, further comprising a selecting means for selecting, from the word sequence pairs generated by the response utterance generating means, only those ones that satisfy a prescribed standard, and storing the selected ones in the word sequence pair storage device.

5. A dialogue device, comprising:
an utterance generating means responsive to an input utterance, for generating a response utterance; and
a storage device for storing a cache record including the response utterance and a key word sequence derived from the input utterance for retrieving the response utterance; wherein
the storage device stores a cache record including a word sequence pair comprised of an utterance word sequence forming a response utterance to an input utterance generated from each of a plurality of passages and a word sequence to be a key for retrieving the utterance word sequence; and
the utterance generating means includes a response utterance retrieving means, responsive to the input utterance, for retrieving, from the storage device, a cache record including, as the key word sequence, an input word sequence derived from the input utterance.

6. A method of creating a generation model used in a dialogue device which, in response to an input utterance, generates a response utterance based on a passage set including a plurality of passages, and includes a storage device for storing a cache record including the response utterance and a key word sequence derived from the input utterance for retrieving the response utterance, the model having a function of generating a record for retrieving a response, the record having the same format as the cache record, based on any passage,
the method of creating the generation model comprising the steps of:
generating a training record used for training the generation model, by combining the response utterance and the key word sequence included in the cache record stored in the storage device with an original passage as the passage used by the dialogue device for generating the response utterance; and
training the generation model, by using, for each of a plurality of training records generated at the step of generating a training record, the original passage included in the training record as an input and a word sequence obtained by shaping the response utterance included in the training record and the key word sequence included in the training record to a prescribed format as a correct answer.

7. The generation model forming method according to claim 6, further comprising the step of selecting, from the cache records stored in the storage device, only that one which satisfies a prescribed standard, and reading the same from the storage device as an input to the step of generating the training record.

8. A natural language sentence generation model creating method, comprising the steps of:
based on an input utterance, creating a plurality of question sentences, inputting them to a question-answering system and thereby obtaining a plurality of answer sentences output from the question-answering system;
based on the plurality of answer sentences obtained at the step of obtaining answer sentence, generating a response utterance to the input utterance;
generating training data for a natural language sentence generation model using, for each of the plurality of answer sentences, the answer sentence as an input and a combination of the response utterance obtained from the answer sentence with the input utterance as correct answer data; and
training the generation model by using the training data generated at the step of generating training data; wherein
in the correct answer data, one of the response utterance and the input utterance is used as a response utterance word sequence and the other is used as a key word sequence for retrieving the response utterance.
